(19) United States
(12) Patent Application Publication
(10) Pub. No.: US 2025/0358663 A1
(43) Pub. Date: Nov. 20, 2025

(54) METHOD AND APPARATUS FOR MEASUREMENT REPORTING IN MOBILE WIRELESS COMMUNICATION SYSTEM

(71) Applicants: Soenghun KIM, Hanam-si (KR); BLACKPIN INC., Seoul (KR)

(72) Inventor: Soenghun KIM, Hanam-si (KR)

(73) Assignees: Soenghun KIM, Hanam-si, GG (KR); BLACKPIN INC., Seoul (KR)

(21) Appl. No.: 19/090,603

(22) Filed: Mar. 26, 2025

(30) Foreign Application Priority Data
May 20, 2024 (KR) 1020240065127

(51) Int. Cl. H04W 24/10; H04W 36/00

(52) U.S. Cl. CPC H04W 24/10; H04W 36/0058

(57) ABSTRACT

A method and apparatus for measurement reporting is provided. The method includes receiving from a base station a first radio resource control message, wherein the first radio resource control message comprises a set of parameters for measurement configuration, performing measurement based on the set of parameters for measurement configuration and performing for a measurement identity a set of operations in case that a report configuration associated with the measurement identity contains event trigger configuration, a specific condition is fulfilled for a set of cells, the set of cells is subset of cells of the first list and a specific indication is configured for the report configuration.

### CROSS-REFERENCE TO RELATED APPLICATION

This application claims priority to and the benefit of Korean Patent Application No. 10-2024-0065127, filed on May 20, 2024, the disclosure of which is incorporated herein by reference in its entirety.

### BACKGROUND

### Technical Field

The present disclosure relates to measurement reporting in a mobile communication system.

### Related Art

The rapid evolution of cellular networks has led to the development of 5G New Radio (NR), which brings unprecedented improvements in speed, capacity, and reliability. As these networks become more complex, efficient measurement reporting mechanisms are crucial for maintaining optimal performance and ensuring seamless user experiences.

NR measurement reporting is a critical component of Radio Resource Management (RRM) in 5G networks. It enables User Equipment (UE) to provide valuable feedback to the network about radio conditions and neighboring cells, which is essential for various network operations such as handover decisions, beam management, and resource allocation.

### SUMMARY

Aspects of the present disclosure are to enhance measurement reporting procedure. The method includes receiving from a base station a first radio resource control message, wherein the first radio resource control message comprises a set of parameters for measurement configuration, performing measurement based on the set of parameters for measurement configuration and performing for a measurement identity a set of operations in case that a report configuration associated with the measurement identity contains event trigger configuration, a specific condition is fulfilled for a set of cells, the set of cells is subset of cells of the first list and a specific indication is configured for the report configuration. To perform the set of operations, the terminal stores the set of cells in the second list, removes the set of cells from the first list, sets measurement identity field in a second radio resource control message to the measurement identity, includes the first set of cells with corresponding measurement results in the second radio resource control message, includes the second set of cells without corresponding measurement result in the second radio resource control message and transmits the second radio resource control message to the base station.

### BRIEF DESCRIPTION OF THE DRAWINGS

FIG. 1A is a diagram illustrating the architecture of a 5G system and a NG-RAN.

FIG. 1B is a diagram illustrating a wireless protocol architecture in a 5G system.

FIG. 2A illustrates the overall operation of the UE and network.

FIG. 2B illustrates RRC connection establishment procedure.

FIG. 2C illustrates RRC connection reconfiguration procedure.

FIG. 2D illustrates data transfer procedure in RRC_CONNECTED state.

FIG. 2E illustrates SS/PBCH block.

FIG. 3A illustrates the operation of the UE and network.

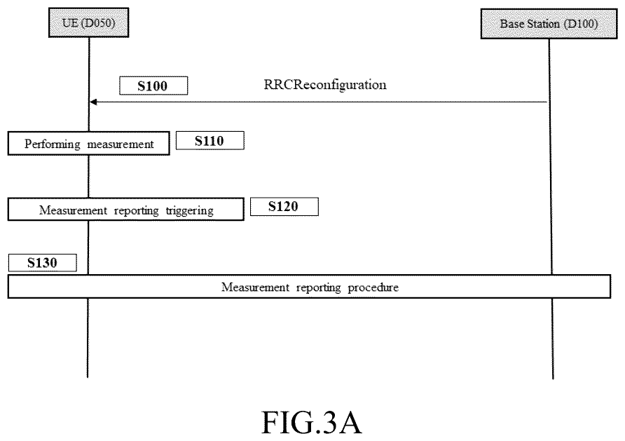

FIG. 4A is a diagram illustrating measurement operations of the terminal.

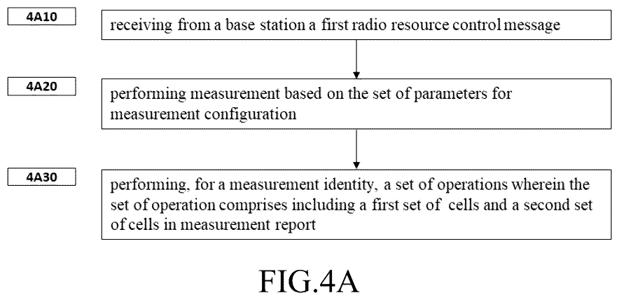

FIG. 5A is a block diagram illustrating the internal structure of a UE according to the disclosure.

FIG. 5B is a block diagram illustrating the internal structure of a base station according to the disclosure.

### DETAILED DESCRIPTION

To facilitate energy saving in network side, a feasible solution is to provide opportunities for turning off downlink transmission in base station. One example of the downlink transmission to be turned off is system information. System information is periodically transmitted to provide unspecified multiple terminals in a cell necessary information for access.

Under certain circumstances, transmission of such system information may not be necessary if access to the cell can be delayed. For example, if the geographical coverage of the cell is covered by another cell, terminal may camp on the other cell (e.g. anchor cell) first and then access to the cell (non-anchor cell) from the other cell, possibly based on assistance information achieved from the other cell.

Hereinafter, embodiments of the present disclosure will be described in detail with reference to the accompanying drawings. In addition, in the description of the present disclosure, if it is determined that a detailed description of a related known function or configuration may unnecessarily obscure the gist of the present disclosure, the detailed description thereof will be omitted. In addition, the terms to be described later are terms defined in consideration of functions in the present disclosure, which may vary according to intentions or customs of users and operators. Therefore, the definition should be made based on the content throughout this specification.

The terms used, in the following description, for indicating access nodes, network entities, messages, interfaces between network entities, and diverse identity information is provided for convenience of explanation. Accordingly, the terms used in the following description are not limited to specific meanings but may be replaced by other terms equivalent in technical meanings.

In the following descriptions, the terms and definitions given in the 3GPP standards are used for convenience of explanation. However, the present disclosure is not limited by use of these terms and definitions and other arbitrary terms and definitions may be employed instead.

In the present disclosure, “trigger” or “triggered” and “initiate” or “initiated” can be used interchangeably.

In the present disclosure, UE and terminal and wireless device can be used interchangeably. In the present disclosure, NG-RAN node and base station and GNB can be used interchangeably.

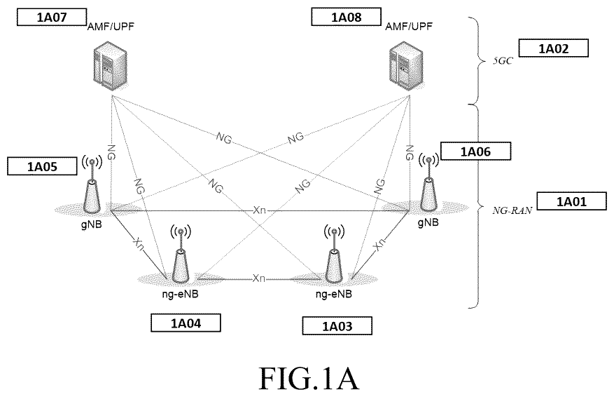

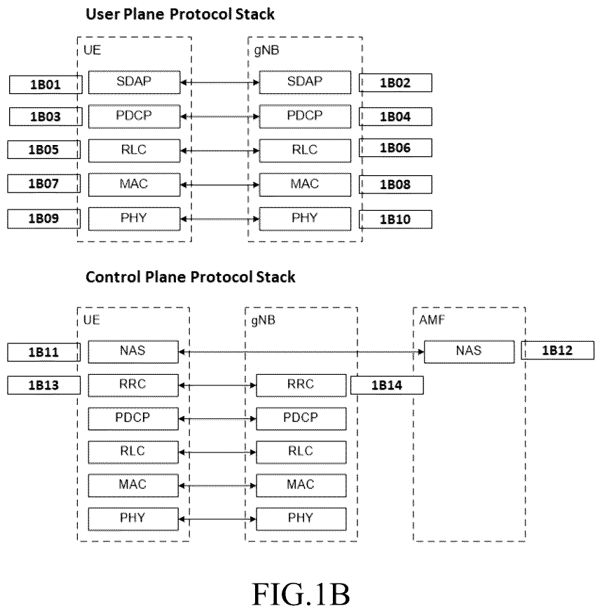

FIG. 1A is a diagram illustrating the architecture of an 5G system and a NG-RAN to which the disclosure may be applied. 5G system consists of NG-RAN 1A01 and 5GC 1A02. An NG-RAN node is either:
1: a gNB, providing NR user plane and control plane protocol terminations towards the UE; or
1: an ng-eNB, providing E-UTRA user plane and control plane protocol terminations towards the UE.

The gNBs 1A05 or 1A06 and ng-eNBs 1A03 or 1A04 are interconnected with each other by means of the Xn interface. The gNBs and ng-eNBs are also connected by means of the NG interfaces to the 5GC, more specifically to the AMF (Access and Mobility Management Function) and to the UPF (User Plane Function). AMF 1A07 and UPF 1A08 may be realized as a physical node or as separate physical nodes.

A gNB 1A05 or 1A06 or an ng-eNBs 1A03 or 1A04 hosts the various functions listed below.
1: Functions for Radio Resource Management such as Radio Bearer Control, Radio Admission Control, Connection Mobility Control, Dynamic allocation of resources to UEs in uplink, downlink and sidelink (scheduling); and
1: IP and Ethernet header compression, uplink data decompression and encryption of user data stream; and
1: Selection of an AMF at UE attachment when no routing to an MME can be determined from the information provided by the UE; and
1: Routing of User Plane data towards UPF; and
1: Scheduling and transmission of paging messages; and
1: Scheduling and transmission of broadcast information (originated from the AMF or O&M); and
1: Measurement and measurement report configuration for mobility and scheduling; and
1: Session Management; and
1: QoS Flow management and mapping to data radio bearers; and
1: Support of UEs in RRC_INACTIVE state; and

The AMF 1A07 hosts the functions such as NAS signaling, NAS signaling security, AS security control, SMF selection, Authentication, Mobility management and positioning management.

The UPF 1A08 hosts the functions such as packet routing and forwarding, transport level packet marking in the uplink, QoS handling and the downlink, mobility anchoring for mobility etc.

FIG. 1B is a diagram illustrating a wireless protocol architecture in an 5G system to which the disclosure may be applied.

The user plane protocol stack consists of SDAP 1B01 or 1B02, PDCP 1B03 or 1B04, RLC 1B05 or 1B06, MAC 1B07 or 1B08 and PHY 1B09 or 1B10. The control plane protocol stack consists of NAS 1B1I or 1B12, RRC 1B13 or 1B14, PDCP, RLC, MAC and PHY.

Each protocol sublayer performs functions related to the operations listed below.
NAS: authentication, mobility management, security control etc.
RRC: System Information, Paging, Establishment, maintenance and release of an RRC connection, Security functions, Establishment, configuration, maintenance and release of Signalling Radio Bearers (SRBs) and Data Radio Bearers (DRBs), Mobility, QoS management, Detection of and recovery from radio link failure, NAS message transfer etc.
SDAP: Mapping between a QoS flow and a data radio bearer, Marking QoS flow ID (QFI) in both DL and UL packets.
PDCP: Transfer of data, Header compression and decompression, Ciphering and deciphering, Integrity protection and integrity verification, Duplication, Reordering and in-order delivery, Out-of-order delivery etc.
RLC: Transfer of upper layer PDUs, Error Correction through ARQ, Segmentation and re-segmentation of RLC SDUs, Reassembly of SDU, RLC re-establishment etc.
MAC: Mapping between logical channels and transport channels, Multiplexing/demultiplexing of MAC SDUs belonging to one or different logical channels into/from transport blocks (TB) delivered to/from the physical layer on transport channels, Scheduling information reporting, Priority handling between UEs, Priority handling between logical channels of one UE etc.
PHY: Channel coding, Physical-layer hybrid-ARQ processing, Rate matching, Scrambling, Modulation, Layer mapping, Downlink Control Information, Uplink Control Information etc.

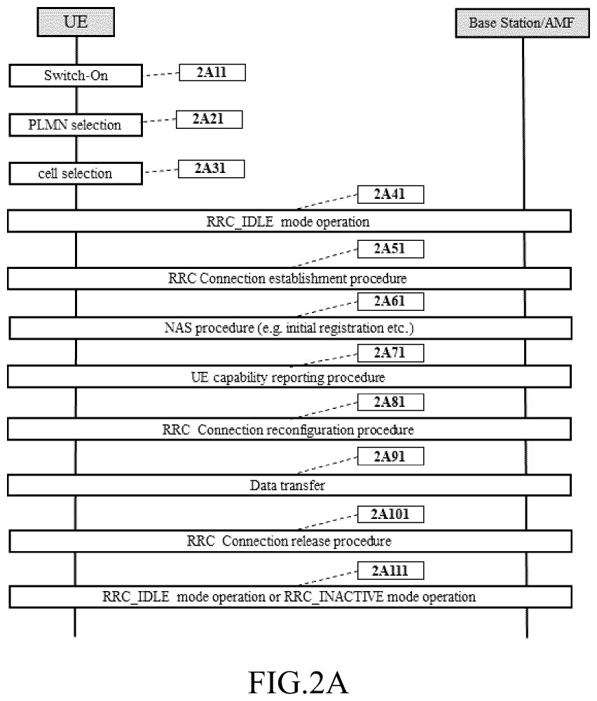

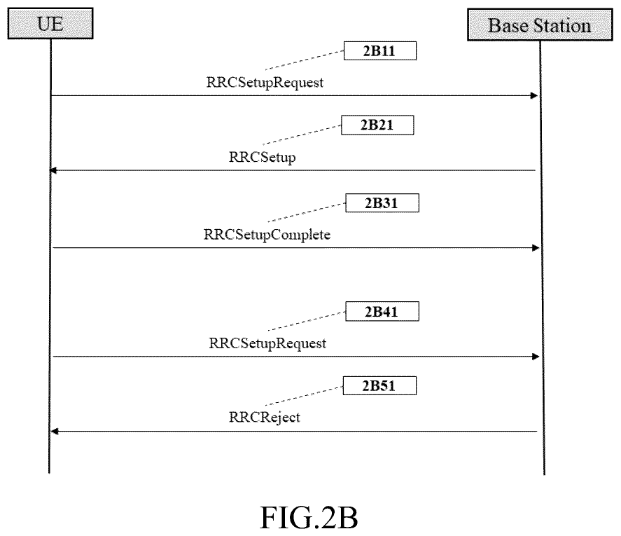

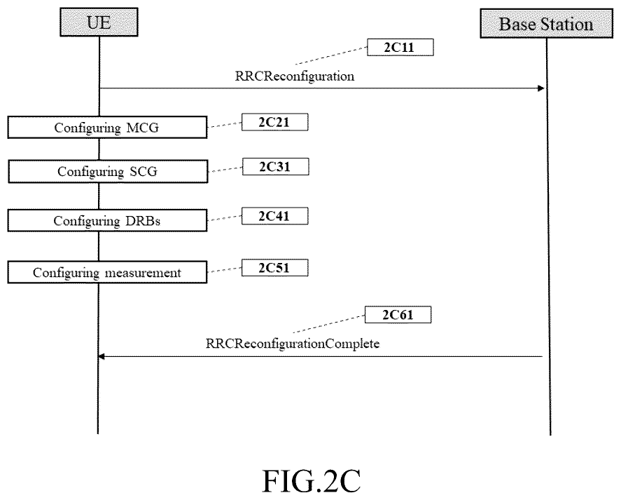

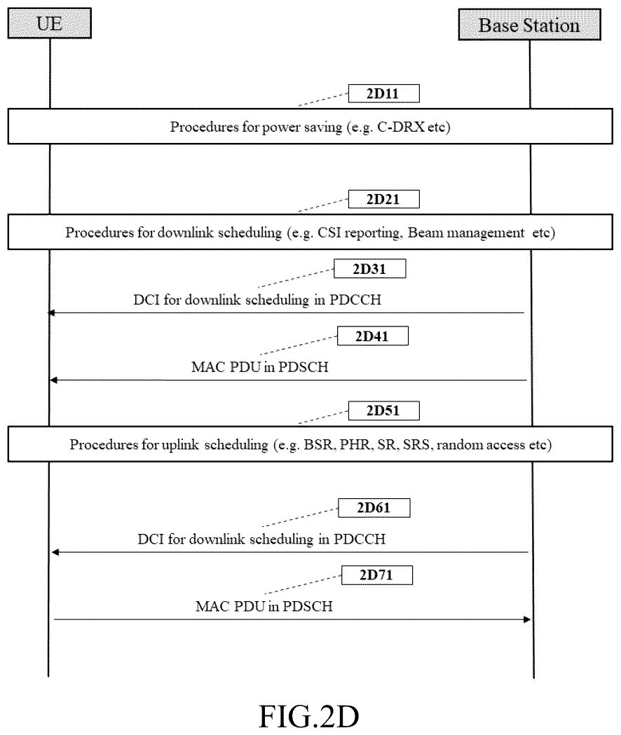

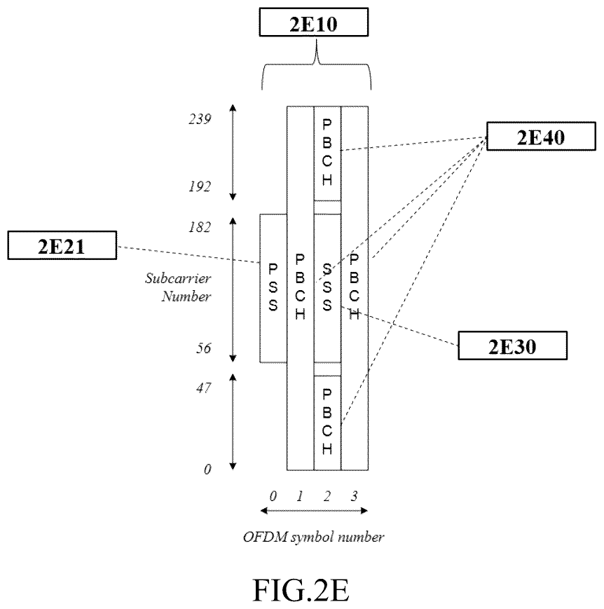

FIG. 2A illustrates overall operation of the UE and network.

Upon switch-on of the wireless device (e.g. UE) 2A11, UE performs PLMN selection 2A21 to select the carrier that is provided by the PLMN that UE is allowed to register.

Then UE performs cell selection 2A31 to camp on a suitable cell.

Once camping on a suitable cell, UE performs RRC_IDLE mode operation 2A41 such as paging channel monitoring and cell reselection and system information acquisition.

UE performs RRC Connection establishment procedure 2A51 to perform e.g. NAS procedure such as initial registration with the selected PLMN.

After successful RRC connection establishment, UE performs NAS procedure 2A61 by transmitting a corresponding NAS message via the established RRC connection (e.g. SRB1).

The base station can trigger UE capability reporting procedure 2A71 before configuring data bearers and various MAC functions.

The base station and the UE perform RRC connection reconfiguration procedure 2A81. Via the procedure, data radio bearers and logical channels and various MAC functions (such as DRX and BSR and PHR and beam failure reporting etc.) and various RRC functions (such as RRM and RLM and measurement etc.) are configured.

The base station and the UE perform data transfer 2A91 via the established radio bearers and based on configured MAC functions and configured RRC functions.

If geographical location of UE changes such that e.g. the current serving cell is no longer providing suitable radio condition, the base station and the UE perform cell level mobility such as handover or conditional reconfiguration or lower layer triggered mobility.

When RRC connection is no longer needed for the UE because of e.g. no more traffic available for the UE, the base station and the UE performs RRC connection release procedure 2A101. The base station can transit UE state either to RRC_IDLE (if the data activity of the UE is expected low) or to RRC_INACTIVE (if the data activity of the UE is expected high).

The UE performs either RRC_IDLE operation or RRC_INACTIVE mode operation 2A111 until the next event to RRC connection establishment/resumption occurs.

FIG. 2B illustrates RRC connection establishment procedure.

Successful RRC connection establishment procedure comprises:
1: transmission of RRCSetupRequest by the UE 2B11;
1: reception of RRCSetup by the UE 2B21;
1: transmission of RRCSetupComplete by the UE 2B31.

Unsuccessful RRC connection establishment procedure comprises:
1: transmission of RRCSetupRequest by the UE 2B41;
1: reception of RRCReject by the UE 2B51;

RRCSetupRequest comprises following fields and IEs:
1: ue-Identity field contains InitialUE-Identity IE which contains:
   2: ng-5G-S-TMSI-Part1 field containing a BIT STRING of 39 bit;
1: establishmentCause field contains EstablishmentCause IE which contains:
   2 enumerated value indicating either emergency, highPriorityAccess, mt-Access, mo-Signalling, mo-Data, mo-VoiceCall, mo-VideoCall, mo-SMS, mps-PriorityAccess, mcs-PriorityAccess etc

RRCSetup comprises following fields and IEs:
1: radioBearerConfig field containing a RadioBearerConfig IE;
1: masterCellGroup field containing a CellGroupConfig IE.

RRCSetupComplete comprises following fields and IEs:
1: selectedPLMN-Identity field containing an integer indicating selected PLMN;
1: dedicatedNAS-Message field containing a DedicatedNAS-Message which may contain various NAS message;
1: ng-5G-S-TMSI-Part2 field containing a BIT STRING of 9 bit.

RRCSetupRequest is transmitted via CCCH/SRB0, which means that the base station does not identify UE transmitting the message based on DCI that scheduling the uplink transmission. The UE includes a field (ue-Identity) in the message so that the base station identifies the UE. If 5G-S-TMSI is available (e.g. UE has already registered to a PLMN), the UE sets the field with part of the 5G-S-TMSI. If 5G-S-TMSI is not available (e.g. UE has not registered to any PLMN), the UE sets the field with 39-bit random value.

Upon reception of RRCSetup, UE configures cell group and SRB1 based on the configuration information in the RRCSetup. The UE perform following actions:
1: perform the cell group configuration procedure in accordance with the received masterCellGroup;
1: perform the radio bearer configuration procedure in accordance with the received radioBearerConfig;
1: if stored, discard the cell reselection priority information provided by the cellReselectionPriorities or inherited from another RAT;
1: enter RRC_CONNECTED;
1: stop the cell re-selection procedure;
1: consider the current cell to be the PCell;

The UE transmits to the base station RRCSetupComplete after performing above actions.

The UE sets the contents of RRCSetupComplete message as follows:
1: set the ng-5G-S-TMSI-Value to ng-5G-S-TMSI-Part2;
1: set the selectedPLMN-Identity to the PLMN selected by upper layers from the plmn-IdentityInfoList;
1: include the s-NSSAI-List and set the content to the values provided by the upper layers;

FIG. 2C illustrates RRC connection reconfiguration procedure.

Based on the reported capability and other factors such as required QoS and call admission control etc, the base station performs RRC reconfiguration procedure with the UE.

RRC reconfiguration procedure is a general purposed procedure that is applied to various use cases such as data radio bearer establishment, handover, cell group reconfiguration, DRX configuration, security key refresh and many others.

RRC reconfiguration procedure consists of exchanging RRCReconfiguration 2C11 and RRCReconfigurationComplete 2C61 between the base station and the UE.

RRCReconfiguration may comprise following fields and IEs:
1: rrc-TransactionIdentifier field contains a RRC-TransactionIdentifier IE;
1: radioBearerConfig field contains a RadioBearerConfig IE;
   2: radioBearerConfig field comprises configuration information for SRBs and DRBs via which RRC messages and user traffic are transmitted and received;
1: secondaryCellGroup field contains a CellGroupConfig IE;
   2: secondaryCellGroup field comprises configuration information for secondary cell group;
   2: A cell group consists of a SpCell and zero or more SCells;
   2: Cell group configuration information comprises cell configuration information for SpCell/SCell and configuration information for MAC and configuration information for logical channel etc;
1: measConfig field contains a MeasConfig IE;
   2: measConfig field comprises configuration information for measurements that the UE is required to perform for mobility and other reasons.
1: masterCellGroup field contains a CellGroupConfig IE; Upon reception of RRCReconfiguration, UE processes the IEs in the order as below.

UE may:
1: perform the cell group configuration for MCG based on the received masterCellGroup 2C21;
1: perform the cell group configuration for SCG based on the received secondaryCellGroup 2C31;
1: perform the radio bearer configuration based on the received radioBearerConfig 2C41;
1: perform the measurement configuration based on the received measConfig 2C51;

After performing configuration based on the received IEs/fields, the UE transmits the RRCReconfigurationComplete to the base station. To indicate that the RRCReconfigurationComplete is the response to RRCReconfiguration, UE sets the TransactionIdentifier field of the RRCReconfigurationComplete with the value indicated in TransactionIdentifier field of the RRCReconfiguration.

FIG. 2D illustrates data transfer procedure in RRC_CONNECTED state.

The UE and the base station may perform procedures for power saving such as C-DRX 2D11. The configuration information for C-DRX is provided to the UE within cell group configuration in the RRCReconfiguration.

The UE and the base station may perform various procedures for downlink scheduling 2D21 such as CSI reporting and beam management. The configuration information for CSI reporting is provided to the UE within cell group configuration in the RRCReconfiguration. Beam management is performed across RRC layer and MAC layer and PHY layer. Beam related information is configured via cell group configuration information within RRCReconfiguration. Activation and deactivation of beam is performed by specific MAC CEs.

Based on the reported CSI and downlink traffic for the UE, the base station determines the frequency/time resource and transmission format for downlink transmission. The base station transmits to the UE DCI containing downlink scheduling information via PDCCH 2D31. The base station transmits to the UE PDSCH corresponding to the DCI and containing a MAC PDU 2D41.

The UE and the base station may perform various procedures for uplink scheduling 2D51 such as buffer status reporting and power headroom reporting and scheduling request and random access. The configuration information for those procedures are provided to the UE in cell group configuration information in RRCReconfiguration.

Based on the uplink scheduling information reported by the UE, the base station determines the frequency/time resource and transmission format for uplink transmission. The base station transmits to the UE DCI containing uplink scheduling information via PDCCH 2D61. The base station transmits to the UE PDSCH corresponding to the DCI and containing a MAC PDU 2D71.

The Synchronization Signal and PBCH block (SSB) 2E10 consists of primary synchronization signals (PSS) 2E20 and secondary synchronization signals (SSS) 2E30. PSS and SSS occupies 1 symbol and 127 subcarriers. PBCH 2E40 spans across 3 OFDM symbols and 240 subcarriers The possible time locations of SSBs within a half-frame are determined by sub-carrier spacing and the periodicity of the half-frames where SSBs are transmitted is configured by the network. During a half-frame, different SSBs may be transmitted in different spatial directions (i.e. using different beams, spanning the coverage area of a cell).

Measurement reporting procedure is an interactive process between the UE and the base station. It is crucial to provide flexible and efficient signaling mechanism to configure measurement reporting procedure. It is especially crucial to enable the base station and network to exchange necessary information timely manner.

Operations of base station D050 and the UE D100 with regards to layer 3 measurement are present below.

At S100, UE receives from a base station a RRCReconfiguration message that contains MeasConfig IE.

The IE MeasConfig specifies measurements to be performed by the UE, and covers intra-frequency, inter-frequency and inter-RAT mobility as well as configuration of measurement gaps.

```
  -- ASN1START
  -- TAG-MEASCONFIG-START
```

| | |
|---|---|
| MeasConfig ::= | SEQUENCE { |
| measObjectToRemoveList | MeasObjectToRemoveList |

OPTIONAL, -- Need N

| | |
|---|---|
| measObjectToAddModList | MeasObjectToAddModList |

OPTIONAL, -- Need N

| | |
|---|---|
| reportConfigToRemoveList | ReportConfigToRemoveList |

OPTIONAL, -- Need N

| | |
|---|---|
| reportConfigToAddModList | ReportConfigToAddModList |

OPTIONAL, -- Need N

| | |
|---|---|
| measIdToRemoveList | MeasIdToRemoveList |

OPTIONAL, -- Need N

| | |
|---|---|
| measIdToAddModList | MeasIdToAddModList |

OPTIONAL, -- Need N

| | |
|---|---|
| s-MeasureConfig | CHOICE { |
| ssb-RSRP | RSRP-Range, |
| csi-RSRP | RSRP-Range |

}
OPTIONAL, -- Need M

| | |
|---|---|
| quantityConfig | QuantityConfig |

OPTIONAL, -- Need M

| | |
|---|---|
| measGapConfig | MeasGapConfig |

OPTIONAL, -- Need M

| | |
|---|---|
| measGapSharingConfig | MeasGapSharingConfig |

```
OPTIONAL, -- Need M
    ...,
    [[
```

| | |
|---|---|
| interFrequencyConfig-NoGap-r16 | ENUMERATED {true} |

```
OPTIONAL -- Need R
    ]],
    [[
```

| | |
|---|---|
| effectiveMeasWindowConfig-r18 | SetupRelease |
| {MeasWindowConfig-r18} | OPTIONAL -- |

```
Need M
    ]]
  }
```

| | |
|---|---|
| MeasObjectToRemoveList ::= | SEQUENCE (SIZE |

(1..maxNrofObjectId)) OF MeasObjectId

| | |
|---|---|
| MeasIdToRemoveList ::= | SEQUENCE (SIZE |

(1..maxNrofMeasId)) OF MeasId

| | |
|---|---|
| ReportConfigToRemoveList ::= | SEQUENCE (SIZE |

```
(1..maxReportConfigId)) OF ReportConfigId
  -- TAG-MEASCONFIG-STOP
  -- ASN1STOP
```

measGapConfig field is used to setup and release measurement gaps in NR.

measIdToAddModList field contains list of measurement identities to add and/or modify.

measIdToRemoveList field contains list of measurement identities to remove.

measObjectToAddModList field contains list of measurement objects to add and/or modify.

measObjectToRemoveList field contains list of measurement objects to remove.

reportConfigToAddModList field contains list of measurement report configurations to add and/or modify.

reportConfigToRemoveList field contains list of measurement report configurations to remove.

s-MeasureConfig field indicates threshold for NR SpCell RSRP measurement controlling when the UE is required to perform measurements on non-serving cells.

The IE MeasObjectToAddModList concerns a list of measurement objects to add or modify.

| -- ASN1START | |
|---|---|
| -- TAG-MEASOBJECTTOADDMODLIST-START | |
| MeasObjectToAddModList ::= | SEQUENCE (SIZE |
| (1..maxNrofObjectId)) OF MeasObjectToAddMod | |
| MeasObjectToAddMod ::= | SEQUENCE { |
| measObjectId | MeasObjectId, |
| measObject | CHOICE { |
| measObjectNR | MeasObjectNR, |
| ..., | |
| measObjectEUTRA | |
| MeasObjectEUTRA, | |
| measObjectUTRA-FDD-r16 | |
| MeasObjectUTRA-FDD-r16, | |
| measObjectNR-SL-r16 | MeasObjectNR- |
| SL-r16, | |
| measObjectCLI-r16 | MeasObjectCLI- |
| r16, | |
| measObjectRxTxDiff-r17 | |
| MeasObjectRxTxDiff-r17, | |
| measObjectRelay-r17 | SL-MeasObject-r16, |
| measObjectNR-SL-r18 | MeasObjectNR- |

```
SL-r18
    }
  }
  -- TAG-MEASOBJECTTOADDMODLIST-STOP
  -- ASN1STOP
```

The IE MeasObjectNR specifies information applicable for SS/PBCH block(s) intra/inter-frequency measurements and/or CSI-RS intra/inter-frequency measurements.

```
  -- ASN1START
  -- TAG-MEASOBJECTNR-START
```

| | |
|---|---|
| MeasObjectNR ::= | SEQUENCE { |
| ssbFrequency | ARFCN-ValueNR |

OPTIONAL, -- Cond SSBorAssociatedSSB

| | |
|---|---|
| ssbSubcarrierSpacing | SubcarrierSpacing |

OPTIONAL, -- Cond SSBorAssociatedSSB

| | |
|---|---|
| smtc1 | SSB-MTC |

OPTIONAL, -- Cond SSBorAssociatedSSB

| | |
|---|---|
| smtc2 | SSB-MTC2 |

OPTIONAL, -- Cond IntraFreqConnected
...

| | |
|---|---|
| nrofSS-BlocksToAverage | INTEGER (2..maxNrofSS- |
| BlocksToAverage) | OPTIONAL, -- Need R |
| nrofCSI-RS-ResourcesToAverage | INTEGER (2..maxNrofCSI-RS- |
| ResourcesToAverage) | OPTIONAL, -- Need R |
| quantityConfigIndex | INTEGER |

(1..maxNrofQuantityConfig),

| | |
|---|---|
| offsetMO | Q-OffsetRangeList, |
| cellsToRemoveList | PCI-List |

OPTIONAL, -- Need N

| | |
|---|---|
| cellsToAddModList | CellsToAddModList |

OPTIONAL, -- Need N

| | |
|---|---|
| excludedCellsToRemoveList | PCI-RangeIndexList |

OPTIONAL, -- Need N

| | |
|---|---|
| excludedCellsToAddModList | SEQUENCE (SIZE |
| (1..maxNrofPCI-Ranges)) OF PCI-RangeElement | OPTIONAL, -- Need N |
| allowedCellsToRemoveList | PCI-RangeIndexList |

OPTIONAL, -- Need N

| | |
|---|---|
| allowedCellsToAddModList | SEQUENCE (SIZE |
| (1..maxNrofPCI-Ranges)) OF PCI-RangeElement | OPTIONAL, -- Need N |

```
    ...,
  ...
  }
```

| | |
|---|---|
| CellsToAddModList ::= | SEQUENCE (SIZE |

(1..maxNrofCellMeas)) OF CellsToAddMod

| | |
|---|---|
| CellsToAddModListExt-v1710 ::= | SEQUENCE (SIZE |

(1..maxNrofCellMeas)) OF CellsToAddModExt-v1710

| | |
|---|---|
| CellsToAddModListExt-v1800 ::= | SEQUENCE (SIZE |

(1..maxNrofCellMeas)) OF CellsToAddModExt-v1800

| | |
|---|---|
| CellsToAddMod ::= | SEQUENCE { |
| physCellId | PhysCellId, |
| cellIndividualOffset | Q-OffsetRangeList |

}

| | |
|---|---|
| CellsToAddModExt-v1710 ::= | SEQUENCE { |
| ntn-PolarizationDL-r17 | ENUMERATED {rhcp,lhcp,linear} |

OPTIONAL, -- Need R

| | |
|---|---|
| ntn-PolarizationUL-r17 | ENUMERATED {rhcp,lhcp,linear} |

OPTIONAL -- Need R
}

| | |
|---|---|
| CellsToAddModExt-v1800 ::= | SEQUENCE { |
| ntn-NeighbourCellInfo-r18 | NTN-NeighbourCellInfo-r18 |

```
OPTIONAL -- Need R
  }
  }
  -- TAG-MEASOBJECTNR-STOP
  -- ASN1STOP
```

cellIndividualOffset field indicates cell individual offsets applicable to a specific cell.

physCellId field indicates physical cell identity of a cell in the cell list.

absThreshCSI-RS-Consolidation field indicates absolute threshold for the consolidation of measurement results per CSI-RS resource(s) from L1 filter(s). The field is used for the derivation of cell measurement results and the reporting of beam measurement information per CSI-RS resource.

absThreshSS-BlocksConsolidation field indicates absolute threshold for the consolidation of measurement results per SS/PBCH block(s) from L1 filter(s). The field is used for the derivation of cell measurement results and the reporting of beam measurement information per SS/PBCH block index.

allowedCellsToAddModList field contains list of cells to add/modify in the allow-list of cells. It applies only to SSB resources.

allowedCellsToRemoveList field contains list of cells to remove from the allow-list of cells.

associatedMeasGapSSB field indicates the associated measurement gap for SSB measuring identified by ssb-ConfigMobility in this measurement object. When multiple MeasObjectNR with the same SSB frequency are configured, the network configures the same measurement gap ID in this field for each MeasObjectNR. If this field is absent, the associated measurement gap is the gap configured via gapFR1, gapFR2, or gapUE.

cellsToAddModList field contains list of cells to add/modify in the cell list.

cellsToRemoveList field contains list of cells to remove from the cell list.

excludedCellsToAddModList field contains list of cells to add/modify in the exclude-list of cells. It applies only to SSB resources.

excludedCellsToRemoveList field contains list of cells to remove from the exclude-list of cells.

measCycleSCell is used only when an SCell is configured on the frequency indicated by the measObjectNR and is in deactivated state.

nrofSS-BlocksToAverage field indicates the maximum number of measurement results per beam based on SS/PBCH blocks to be averaged. The same value applies for each detected cell associated with this MeasObject.

offsetMO field indicates offset values applicable to all measured cells with reference signal(s) indicated in this MeasObjectNR.

smtc1 field contains primary measurement timing configuration.

smtc2 field contains secondary measurement timing configuration for SS corresponding to this MeasObjectNR with PCI listed in pci-List.

ssbFrequency field indicates the frequency of the SS associated to this MeasObjectNR.

ssbSubcarrierSpacing field indicates subcarrier spacing of SSB.

The IE ReportConfigNR specifies criteria for triggering of an NR measurement reporting event or of a CHO, CPA or CPC event or of an L2 U2N relay measurement reporting event. For events labelled AN with N equal to 1, 2 and so on, measurement reporting events and CHO, CPA or CPC events are based on cell measurement results, which can either be derived based on SS/PBCH block or CSI-RS.
Event A1: Serving becomes better than absolute threshold;
Event A2: Serving becomes worse than absolute threshold;
Event A3: Neighbour becomes amount of offset better than PCell/PSCell;
Event A4: Neighbour becomes better than absolute threshold;
Event A5: PCell/PSCell becomes worse than absolute threshold1 AND Neighbour/SCell becomes better than another absolute threshold2;
Event A6: Neighbour becomes amount of offset better than SCell;
Event D1: Distance between UE and a reference location referenceLocation1 becomes larger than configured threshold distanceThreshFromReference1 and distance between UE and a reference location referenceLocation2 becomes shorter than configured threshold distanceThreshFromReference2;
Event D2: Distance between UE and a moving reference location based on movingReferenceLocation and its corresponding satellite ephemeris and epoch time broadcast in SIB19 for the serving cell becomes larger than configured threshold distanceThreshFromReference1 and distance between UE and a moving reference location determined based on referenceLocation2 becomes shorter than configured threshold distanceThreshFromReference2;
CondEvent A3: Conditional reconfiguration candidate becomes amount of offset better than PCell/PSCell;
CondEvent A4: Conditional reconfiguration candidate becomes better than absolute threshold where condEventA4 can also be used for current PSCell (i.e., in case it is configured as candidate PSCell for CondEvent A4 evaluation) for CHO with candidate SCG(s) case;
CondEvent A5: PCell/PSCell becomes worse than absolute threshold1 AND Conditional reconfiguration candidate becomes better than another absolute threshold2;
CondEvent D1: Distance between UE and a reference location referenceLocation1 becomes larger than configured threshold distanceThreshFromReference1 and distance between UE and a reference location referenceLocation2 of conditional reconfiguration candidate becomes shorter than configured threshold distanceThreshFromReference2;
CondEvent D2: Distance between UE and a moving reference location determined based on movingReferenceLocation and its corresponding satellite ephemeris and epoch time broadcast in SIB19 for the serving cell becomes larger than configured threshold distanceThreshFromReference1 and distance between UE and a moving reference location determined based on referenceLocation2 of conditional reconfiguration candidate becomes shorter than configured threshold distanceThreshFromReference2;
CondEvent T1: Time measured at UE becomes more than configured threshold t1-Threshold but is less than t1-Threshold+duration;
Event X1: Serving L2 U2N Relay UE becomes worse than absolute threshold1 AND NR Cell becomes better than another absolute threshold2;
Event X2: Serving L2 U2N Relay UE becomes worse than absolute threshold;
For event I1, measurement reporting event is based on CLI measurement results, which can either be derived based on SRS-RSRP or CLI-RSSI.
Event I1: Interference becomes higher than absolute threshold;
The reporting events concerning Aerial UE altitude are labelled HN with N equal to 1 and 2. Additionally, the reporting events concerning Aerial UE altitude and the neighboring cell measurements simultaneously are labelled AMHN with M equal to 3, 4, 5 and N equal to 1, 2.
Event H1: Aerial UE altitude becomes higher than a threshold;
Event H2: Aerial UE altitude becomes lower than a threshold;
Event A3H1: Neighbour becomes offset better than SpCell and the Aerial UE altitude becomes higher than a threshold;
Event A3H2: Neighbour becomes offset better than SpCell and the Aerial UE altitude becomes lower than a threshold;
Event A4H1: Neighbour becomes better than threshold1 and the Aerial UE altitude becomes higher than a threshold2;
Event A4H2: Neighbour becomes better than threshold1 and the Aerial UE altitude becomes lower than a threshold2;
Event A5H1: SpCell becomes worse than threshold1 and neighbour becomes better than threshold2 and the Aerial UE altitude becomes higher than a threshold3;
Event A5H2: SpCell becomes worse than threshold1 and neighbour becomes better than threshold2 and the Aerial UE altitude becomes lower than a threshold3.

reportType field indicates type of the configured measurement report. In MR-DC, network does not configure report of type reportCGI using SRB3. The condTriggerConfig is used for CHO, CPA or CPC configuration.

a3-Offset/a6-Offset field indicates offset value(s) to be used in NR measurement report triggering condition for event a3/a6. The actual value is field value*0.5 dB.

aN-ThresholdM field indicates threshold value associated to the selected trigger quantity (e.g. RSRP, RSRQ, SINR) per RS Type (e.g. SS/PBCH block, CSI-RS) to be used in NR measurement report triggering condition for event number aN. If multiple thresholds are defined for event number aN, the thresholds are differentiated by M. In the same eventA5, eventA5H1, eventA5H2, the network configures the same quantity for the MeasTriggerQuantity of the a5-Threshold1 and for the MeasTriggerQuantity of the a5-Threshold2.

eventId field contains choice of NR event triggered reporting criteria.

maxNrofRS-IndexesToReport field indicates max number of RS indexes to include in the measurement report for A1-A6 events.

maxReportCells field indicates max number of non-serving cells to include in the measurement report.

numberOfTriggeringCells field indicates the number of cells detected that are required to fulfill an event for a measurement report to be triggered. This field is applicable only for the events concerning neighbor cells, i.e. eventA3, eventA4, eventA5, eventA3H1, eventA3H2, eventA4H1, eventA4H2, eventA5H1, eventA5H2.

reportAddNeighMeas field indicates that the UE shall include the best neighbour cells per serving frequency.

reportAmount field indicates number of measurement reports applicable for eventTriggered as well as for periodical report types.

reportOnLeave field indicates whether or not the UE shall initiate the measurement reporting procedure when the leaving condition is met for a cell in cellsTriggeredList.

reportQuantityCell field indicates the cell measurement quantities to be included in the measurement report.

reportQuantityRS-Indexes field indicates which measurement information per RS index the UE shall include in the measurement report.

timeToTrigger field indicates time during which specific criteria for the event needs to be met in order to trigger a measurement report.

useAllowedCellList field indicates whether only the cells included in the allow-list of the associated measObject are applicable.

xN-ThresholdM field indicates threshold value associated to the selected trigger quantity (e.g. RSRP, RSRQ, SINR) per RS Type (e.g. SS/PBCH block, CSI-RS) to be used in NR measurement report triggering condition for event xN. If multiple thresholds are defined for event number xN, the thresholds are differentiated by M. x1-Threshold1 and x2-Threshold indicates the threshold value for the serving L2 U2N Relay UE, x1-Threshold2 indicates the threshold value for the NR Cells.

cellIndividualOffset field indicates cell individual offsets applicable to a specific measurement event.

physCellId field indicates physical cell identity of a cell in the cell list.

LeaveReport field indicates whether or not the UE shall include LeaveList in the measurement report when measurement reporting procedure is initiated when leaving condition is met for one or more cells in cellsTriggeredList.

At S110, UE performs measurement based on measurement configuration. For each measObject that is associated with at least one measId, UE performs the following.
if the measObject is associated to NR and the rsType is set to ssb:
if reportQuantityRS-Indexes and maxNrofRS-IndexesToReport for the associated reportConfig are configured:
   UE derives layer 3 beam measurements only based on SS/PBCH block for each measurement quantity indicated in reportQuantityRS-Indexes;
UE derives cell measurement results based on SS/PBCH block for the trigger quantity and each measurement quantity indicated in reportQuantityCell using parameters from the associated measObject, as described in <Derivation of cell measurement results>.

### <Derivation of Cell Measurement Results>

The UE shall:
for each cell measurement quantity to be derived based on SS/PBCH block:
   if nrofSS-BlocksToAverage is not configured in the associated measObject in RRC_CONNECTED or in the associated entry in measIdleCarrierListNR within VarMeasIdleConfig in RRC_IDLE/RRC_INACTIVE; or
   if absThreshSS-BlocksConsolidation is not configured in the associated measObject in RRC_CONNECTED or in the associated entry in measIdleCarrierListNR within VarMeasIdleConfig in RRC_IDLE/RRC_INACTIVE; or
   if the highest beam measurement quantity value is below or equal to absThreshSS-BlocksConsolidation:
      derive each cell measurement quantity based on SS/PBCH block as the highest beam measurement quantity value;
   else:
      derive each cell measurement quantity based on SS/PBCH block as the linear power scale average of the highest beam measurement quantity values above absThreshSS-BlocksConsolidation where the total number of averaged beams shall not exceed nrofSS-BlocksToAverage;
At S120, UE determines for each measId whether to trigger measurement reporting as follows.
for each measId included in the measIdList within VarMeasConfig:
   if the reportType is set to eventTriggered, and if the entry condition applicable for this event, i.e. the event corresponding with the eventId of the corresponding reportConfig within VarMeasConfig, is fulfilled for one or more applicable cells for all measurements after layer 3 filtering taken during timeToTrigger defined for this event within the VarMeasConfig:
      include a measurement reporting entry within the VarMeasReportList for this measId;
      include the concerned cell(s) in the cellsTriggeredList defined within the VarMeasReportList for this measId;
      initiate the measurement reporting procedure;
   if the reportType is set to eventTriggered and if the leaving condition applicable for this event is fulfilled for one or more of the cells included in the cellsTriggeredList defined within the VarMeasReportList for this measId for all measurements after layer 3 filtering taken during timeToTrigger defined within the VarMeasConfig for this event:
      if enteringLeavingReport is configured for the corresponding report configuration:
   store the concerned cell(s) in the cellsMetLeavingCond defined within the VarMeasReportList for this measId;
      remove the concerned cell(s) in the cellsTriggeredList defined within the VarMeasReportList for this measId;
      if reportOnLeave is set to true for the corresponding report configuration:
         if the corresponding reportConfig does not include numberOfTriggeringCells; or
         if the corresponding reportConfig includes numberOfTriggeringCells and a measurement report was previously sent to the network for at least one of the concerned cell(s):
         initiate the measurement reporting procedure;
      remove all the concerned cell(s) from cellsMetLeavingCond defined within the VarMeasReportList for this measId, if any;
      if the cellsTriggeredList defined within the VarMeasReportList for this measId is empty:
         remove the measurement reporting entry within the VarMeasReportList for this measId;
At S130, UE performs measurement reporting procedure.

For the measId for which the measurement reporting procedure was triggered, the UE shall set the measResults within the MeasurementReport message as follows:
set the measId to the measurement identity that triggered the measurement reporting;
for each serving cell configured with servingCellMO:
   set the measResultServingCell within measResultServingMOList to include RSRP, RSRQ and the available SINR of the serving cell, derived based on SSB;
set the measResultNeighCells to include the best neighbouring cells up to maxReportCells in accordance with the following:
   if the reportType is set to eventTriggered and eventId is not set to eventD1 or eventD2 or eventH1 or eventH2:
      include the cells included in the cellsTriggeredList as defined within the VarMeasReportList for this measId;
   for each cell that is included in the measResultNeighCells, include the physCellId;
   if the reportType is set to eventTriggered:
      for each included cell, include the layer 3 filtered measured results in accordance with the reportConfig for this measId, ordered as follows:
         set resultsSSB-Cell within the measResult to include the SS/PBCH block based quantity(ies) indicated in the reportQuantityCell within the concerned reportConfig, in decreasing order of the sorting quantity, i.e. the best cell is included first;
      if reportType is set to eventTriggered and reportOnBestCellChange is configured:
         if reportOnBestCellChange is set to n1:
         set the reportedBestNeighbourCell defined within the VarMeasReportList for this measId to the first cell listed in the measResultNeighCells;
         if reportOnBestCellChange is set to n2:
         set the first cell in reportedBestNeighbourCell defined within the VarMeasReportList for this measId to the first cell listed in the measResultNeighCells and the second cell in reportedBestNeighbourCell defined within the VarMeasReportList for this measId to the second cell listed in the measResultNeighCells, if available;
if reportConfig associated with the measId that triggered the measurement reporting is set to eventTriggered and if enteringLeavingReport is configured:
   for each cell that is included in measResultNeighCells:
      if the measObject associated with this measId concerns NR:
         if event entry condition for the event that triggered this measurement report has been fulfilled for the cell and the cell has just been included to cellsTriggeredList:
         set entering to true for the concerned NR cell;
   if the field cellsMetLeavingCond within the VarMeasReportList for this measId is not empty:
      set cellsMetReportOnLeaveList to include the cell(s) in cellsMetLeavingCond.

Terminal receives from a base station a RRCReconfiguration/MeasConfig.

Terminal performs measurement configuration. Terminal configures a measId by associating the measId with a specific ReportConfig and a specific measObject.

Terminal performs, for the measId, measurement on one or more cells. Terminal, for each of one or more cells, derives cell measurement results by measuring one or multiple beams associated with the cell.

Terminal triggers measurement report for a measId based on reportConfig associated with the measId and the cell measurement results.

Terminal, if a specific set of conditions are met, generates a measurement report to report that at least one cell is removed from the cellsTriggeredList associated with the measId. The measurement report comprises LeaveList.

Terminal transmits to the base station the measurement report.

The specific set of conditions are:
For reportConfig associated with the measId that triggered the measurement reporting:
   reportType is set to eventTriggered; and
   eventide is either eventA1, eventA2, eventA3, eventA4, eventA5 or A6 (and neither eventD1, eventD2, eventH1, eventH2, eventA3H1, eventA3H2, eventA4H1, eventA4H2, eventA5H1 nor eventA5H2); and
   Both reportOnLeave and LeaveReport are set to true for the reportConfig; and
   leaving condition for this event is fulfilled for one or more of cells that were included in the cellsTriggeredList for this measId when leaving condition for this event is fulfilled;
The LeaveList comprises one or more PCIs of the one or more cells (that were included in the cellsTriggeredList for this measId when leaving condition for this event is fulfilled).

cellsTriggeredList for a measId comprises one or more PCIs of one or more cells that triggered measurement reporting procedure due to entering condition is met for the one or more cells.

cellsTriggeredList for a measId is managed as followings.

The terminal includes PCIs of one or more cells in the LeaveList after UE removed the PCIs of the one or more cells from the cellsTriggeredList.

Adding one or more cells to the list is performed as follows.
if the reportType is set to eventTriggered, and if the corresponding reportConfig does not include numberOfTriggeringCells, and if the entry condition applicable for this event, i.e. the event corresponding with the eventId of the corresponding reportConfig within VarMeasConfig, is fulfilled for one or more applicable cells for all measurements after layer 3 filtering taken during timeToTrigger defined for this event within the VarMeasConfig, while the VarMeasReportList does not include a measurement reporting entry for this measId (a first cell triggers the event):
   include a measurement reporting entry within the VarMeasReportList for this measId;
   set the numberOfReportsSent defined within the VarMeasReportList for this measId to 0;
   include the concerned cell(s) (the applicable cells to which entry condition is fulfilled) in the cellsTriggeredList defined within the VarMeasReportList for this measId;
else if the reportType is set to eventTriggered, and if the corresponding reportConfig does not include numberOfTriggeringCells, and if the entry condition applicable for this event, i.e. the event corresponding with the eventId of the corresponding reportConfig within VarMeasConfig, is fulfilled for one or more applicable cells not included in the cellsTriggeredList for all measurements after layer 3 filtering taken during timeToTrigger defined for this event within the VarMeasConfig (a subsequent cell triggers the event):
   set the numberOfReportsSent defined within the VarMeasReportList for this measId to 0;
   include the concerned cell(s) (the applicable cells to which entry condition is fulfilled) in the cellsTriggeredList defined within the VarMeasReportList for this measId;

Removing one or more cells from the list.
if the reportType is set to eventTriggered and if the leaving condition applicable for this event is fulfilled for one or more of the cells included in the cellsTriggeredList defined within the VarMeasReportList for this measId for all measurements after layer 3 filtering taken during timeToTrigger defined within the VarMeasConfig for this event:
   remove the concerned cell(s) in the cellsTriggeredList defined within the VarMeasReportList for this measId;
   if reportOnLeave is set to true for the corresponding report configuration:
      if the corresponding reportConfig does not include numberOfTriggeringCells; or
      if the corresponding reportConfig includes numberOfTriggeringCells and a measurement report was previously sent to the network for at least one of the concerned cell(s):
         initiate the measurement reporting procedure;
      if the cellsTriggeredList defined within the VarMeasReportList for this measId is empty:
      remove the measurement reporting entry within the VarMeasReportList for this measId;
      stop the periodical reporting timer for this measId, if running;

cellsMetLeavingCond and LeaveList are used interchangeably.

enteringLeavingReport and LeaveReport are used interchangeably.

The measurement configuration includes the following parameters: Measurement objects: A list of objects on which the UE shall perform the measurements.
For intra-frequency and inter-frequency measurements a measurement object indicates the frequency/time location and subcarrier spacing of reference signals to be measured. Associated with this measurement object, the network may configure a list of cell specific offsets, a list of ‘exclude-listed’ cells and a list of ‘allow-listed’ cells. Exclude-listed cells are not applicable in event evaluation or measurement reporting. Allow-listed cells are the only ones applicable in event evaluation or measurement reporting.
The measObjectId of the MO which corresponds to each serving cell is indicated by servingCellMO within the serving cell configuration.
For inter-RAT E-UTRA measurements a measurement object is a single E-UTRA carrier frequency. Associated with this E-UTRA carrier frequency, the network can configure a list of cell specific offsets and a list of ‘exclude-listed’ cells. Exclude-listed cells are not applicable in event evaluation or measurement reporting.
For inter-RAT UTRA-FDD measurements a measurement object is a set of cells on a single UTRA-FDD carrier frequency.
For NR sidelink measurements of L2 U2N Relay UEs, a measurement object is a single NR sidelink frequency to be measured.
For CBR measurement of NR sidelink communication, a measurement object is a set of transmission resource pool(s) on a single carrier frequency for NR sidelink communication.
For CBR measurement of NR sidelink discovery, a measurement object is a set of discovery dedicated resource pool(s) or transmission resource pool(s) also used for NR sidelink discovery on a single carrier frequency for NR sidelink discovery.
For CBR measurement of NR sidelink positioning, a measurement object is a set of positioning dedicated resource pool(s) or transmission resource pool(s) also used for NR sidelink positioning on a single carrier frequency for NR sidelink positioning.
For CLI measurements a measurement object indicates the frequency/time location of SRS resources and/or CLI-RSSI resources, and subcarrier spacing of SRS resources to be measured.

Report configurations: A list of report configurations where there can be one or multiple report configurations per measurement object. Each measurement report configuration consists of the following:
Reporting criterion: The criterion that triggers the UE to send a measurement report. This can either be periodical or a single event description.
RS type: The RS that the UE uses for beam and cell measurement results (SS/PBCH block or CSI-RS).
Reporting format: The quantities per cell and per beam that the UE includes in the measurement report (e.g. RSRP) and other associated information such as the maximum number of cells and the maximum number beams per cell to report.

In case of conditional reconfiguration, each configuration consists of the following:
Execution criteria: The criteria the UE uses for conditional reconfiguration execution.
RS type: The RS that the UE uses for obtaining beam and cell measurement results (SS/PBCH block-based or CSI-RS-based), used for evaluating conditional reconfiguration execution condition.

Measurement identities: For measurement reporting, a list of measurement identities where each measurement identity links one measurement object with one report configuration. By configuring multiple measurement identities, it is possible to link more than one measurement object to the same report configuration, as well as to link more than one report configuration to the same measurement object. The measurement identity is also included in the measurement report that triggered the reporting, serving as a reference to the network. For conditional reconfiguration triggering, one measurement identity links to exactly one conditional reconfiguration trigger configuration. And up to 2 measurement identities can be linked to one conditional reconfiguration execution condition.

Quantity configurations: The quantity configuration defines the measurement filtering configuration used for all event evaluation and related reporting, and for periodical reporting of that measurement. For NR measurements, the network may configure up to 2 quantity configurations with a reference in the NR measurement object to the configuration that is to be used. In each configuration, different filter coefficients can be configured for different measurement quantities, for different RS types, and for measurements per cell and per beam.

Measurement gaps: Periods that the UE may use to perform measurements.

Effective measurement window: Periods that the UE may use to perform inter RAT measurements.

For performing measurement, the UE shall:
whenever the UE has a measConfig, perform RSRP and RSRQ measurements for each serving cell for which servingCellMO is configured as follows:
   if the reportConfig associated with at least one measId included in the measIdList within VarMeasConfig contains an rsType set to ssb and ssb-ConfigMobility is configured in the measObject indicated by the servingCellMO:
      if the reportConfig associated with at least one measId included in the measIdList within VarMeasConfig contains a reportQuantityRS-Indexes and maxNrofRS-IndexesToReport and contains an rsType set to ssb:
         UE derive layer 3 filtered RSRP and RSRQ per beam for the serving cell based on SS/PBCH blocks;
      UE derive serving cell measurement results based on SS/PBCH block;
   if the reportConfig associated with at least one measId included in the measIdList within VarMeasConfig contains an rsType set to csi-rs and CSI-RS-ResourceConfigMobility is configured in the measObject indicated by the servingCellMO:
      if the reportConfig associated with at least one measId included in the measIdList within VarMeasConfig contains a reportQuantityRS-Indexes and maxNrofRS-IndexesToReport and contains an rsType set to csi-rs:
         UE derive layer 3 filtered RSRP and RSRQ per beam for the serving cell based on CSI-RSa;
      UE derive serving cell measurement results based on CSI-RS;
for each serving cell for which servingCellMO is configured, if the reportConfig associated with at least one measId included in the measIdList within VarMeasConfig contains SINR as trigger quantity and/or reporting quantity:
   if the reportConfig contains rsType set to ssb and ssb-ConfigMobility is configured in the servingCellMO:
      if the reportConfigcontains a reportQuantityRS-Indexes and maxNrofRS-IndexesToReport:
         UE derive layer 3 filtered SINR per beam for the serving cell based on SS/PBCH blocks;
      UE derive serving cell SINR based on SS/PBCH block;
   if the reportConfig contains rsType set to csi-rs and CSI-RS-ResourceConfigMobility is configured in the servingCellMO:
      if the reportConfigcontains a reportQuantityRS-Indexes and maxNrofRS-IndexesToReport:
         UE derive layer 3 filtered SINR per beam for the serving cell based on CSI-RSa;
      UE derive serving cell SINR based on CSI-RS;
for each measId included in the measIdList within VarMeasConfig:
   if the reportType for the associated reportConfig is set to reportCGI and timer T321 is running:
      if useAutonomousGaps is configured for the associated reportConfig:
         UE perform the corresponding measurements on the frequency and RAT indicated in the associated measObject using autonomous gaps as necessary;
      else:
         UE perform the corresponding measurements on the frequency and RAT indicated in the associated measObject using available idle periods;
      if the cell indicated by reportCGI field for the associated measObject is an NR cell and that indicated cell is broadcasting SIB1:
         UE try to acquire SIB1 in the concerned cell;
      if the cell indicated by reportCGI field is an E-UTRA cell:
         UE try to acquire SystemInformationBlockType1 in the concerned cell;
   if the ul-DelayValueConfig is configured for the associated reportConfig:
      UE ignore the measObject;
      for each of the configured DRBs, configure the PDCP layer to perform corresponding average UL PDCP packet delay measurement per DRB;
   if the ul-ExcessDelayConfig is configured for the associated reportConfig:
      UE ignore the measObject;
      for each of the configured DRBs, configure the PDCP layer to perform corresponding UL PDCP Excess Packet Delay delay measurement according to the configured threshold per DRB;
   if the reportType for the associated reportConfig is periodical, eventTriggered; or
   if the reportType for the associated reportConfig is condTriggerConfig, the measId is within the MCG VarMeasConfig and is indicated in the condExecutionCond or in the condExecutionCondPSCell associated to a condReconfigId in the MCG VarConditionalReconfig (for CHO, CPA, MN-initiated inter-SN CPC, or subsequent CPAC in NR-DC); or
   if the reportType for the associated reportConfig is condTriggerConfig, the measId is within the SCG VarMeasConfig and is indicated in the condExecutionCond associated to a condReconfigId in the SCG VarConditionalReconfig (for intra-SN CPC or subsequent CPAC); or
   if the reportType for the associated reportConfig is condTriggerConfig, the measId is within the SCG VarMeasConfig and is indicated in the condExecutionCondSCG associated to a condReconfigId in the MCG VarConditionalReconfig (for SN-initiated inter-SN CPC or subsequent CPAC in NR-DC); or
   if the reportType for the associated reportConfig is condTriggerConfig, the measId is within the SCG VarMeasConfig and is indicated in the triggerConditionSN associated to a condReconfigurationld in VarConditionalReconfiguration (for SN-initiated inter-SN CPC in EN-DC):
      if a measurement gap configuration is setup, or
      if the UE does not require measurement gaps to perform the concerned measurements:
         if s-MeasureConfig is not configured, or
         if s-MeasureConfig is set to ssb-RSRP and the NR SpCell RSRP based on SS/PBCH block, after layer 3 filtering, is lower than ssb-RSRP, or
         if s-MeasureConfig is set to csi-RSRP and the NR SpCell RSRP based on CSI-RS, after layer 3 filtering, is lower than csi-RSRP:
         if the measObject is associated to NR and the rsType is set to csi-rs:
         if reportQuantityRS-Indexes and maxNrofRS-IndexesToReport for the associated reportConfig are configured:
         UE derive layer 3 filtered beam measurements only based on CSI-RS for each measurement quantity indicated in reportQuantityRS-Indexes;
         UE derive cell measurement results based on CSI-RS for the trigger quantity and each measurement quantity indicated in reportQuantityCell using parameters from the associated measObject;
         if the measObject is associated to NR and the rsType is set to ssb:
         if reportQuantityRS-Indexes and maxNrofRS-IndexesToReport for the associated reportConfig are configured:
         UE derive layer 3 beam measurements only based on SS/PBCH block for each measurement quantity indicated in reportQuantityRS-Indexesa;
         UE derive cell measurement results based on SS/PBCH block for the trigger quantity and each measurement quantity indicated in reportQuantityCell using parameters from the associated measObject;
         if the measObject is associated to E-UTRA:
         UE perform the corresponding measurements associated to neighbouring cells on the frequencies indicated in the concerned measObject;
         if the measObject is associated to UTRA-FDD:
         UE perform the corresponding measurements associated to neighbouring cells on the frequencies indicated in the concerned measObject;
         if the measObject is associated to L2 U2N Relay UE:
         UE perform the corresponding measurements associated to candidate Relay UEs on the frequencies indicated in the concerned measObject
         if the measRSSI-ReportConfig is configured in the associated reportConfig:
         UE perform the RSSI and channel occupancy measurements on the frequency configured by rmtc-Frequency in the associated measObject;
The network avoids configuring UEs supporting only CHO and/or Rel-16 CPC with measurements not referred to by any execution condition.
   if the reportType for the associated reportConfig is set to reportSFTD and the numberOfReportsSent as defined within the VarMeasReportList for this measId is less than one:
      if the reportSFTD-Meas is set to true:
         if the measObject is associated to E-UTRA:
         UE perform SFTD measurements between the PCell and the E-UTRA PSCell;
         if the reportRSRP is set to true;
         UE perform RSRP measurements for the E-UTRA PSCell;
         else if the measObject is associated to NR:
         UE perform SFTD measurements between the PCell and the NR PSCell;
         if the reportRSRP is set to true;
         UE perform RSRP measurements for the NR PSCell based on SSB;
      else if the reportSFTD-NeighMeas is included:
         if the measObject is associated to NR:
         if the drx-SFTD-NeighMeas is included:
         UE perform SFTD measurements between the PCell and the NR neighbouring cell(s) detected based on parameters in the associated measObject using available idle periods;
         else:
         UE perform SFTD measurements between the PCell and the NR neighbouring cell(s) detected based on parameters in the associated measObject;
         if the reportRSRP is set to true:
         UE perform RSRP measurements based on SSB for the NR neighbouring cell(s) detected based on parameters in the associated measObject;
   if the reportType for the associated reportConfig is cli-Periodical or cli-EventTriggered:
      UE perform the corresponding measurements associated to CLI measurement resources indicated in the concerned measObjectCLI;
   UE perform the evaluation of reporting criteria, except if reportConfig is condTriggerConfig.

For measurement report triggering, UE performs the following.
for each measId included in the measIdList within VarMeasConfig:
   if the corresponding reportConfig includes a reportType set to eventTriggered or periodical:
      if the corresponding measObject concerns NR:
         if the eventA1 or eventA2 is configured in the corresponding reportConfig:
         UE consider only the serving cell to be applicable;
         if the eventA3 or eventA5 or eventA3H1 or eventA3H2 or eventA5H1 or eventA5H2 is configured in the corresponding reportConfig:
         if a serving cell is associated with a measObjectNR and neighbours are associated with another measObjectNR, consider any serving cell associated with the other measObjectNR to be a neighbouring cell as well;
         if corresponding reportConfig includes reportType set to periodical; or
         for measurement events other than eventA1, eventA2, eventD1, eventD2, eventX2, eventH1 or eventH2:
         if useAllowedCellList is set to true:
         UE consider any neighbouring cell detected based on parameters in the associated measObjectNR to be applicable when the concerned cell is included in the allowedCellsToAddModList defined within the VarMeasConfig for this measId;
         else:
         UE consider any neighbouring cell detected based on parameters in the associated measObjectNR to be applicable when the concerned cell is not included in the excludedCellsToAddModList defined within the VarMeasConfig for this measId;
      else if the corresponding measObject concerns E-UTRA:
         if eventB1 or eventB2 is configured in the corresponding reportConfig:
         UE consider a serving cell, if any, on the associated E-UTRA frequency as neighbour cell;
         UE consider any neighbouring cell detected on the associated frequency to be applicable when the concerned cell is not included in the excludedCellsToAddModListEUTRAN defined within the VarMeasConfig for this measId;
      else if the corresponding measObject concerns UTRA-FDD:
         if eventB1-UTRA-FDD or eventB2-UTRA-FDD is configured in the corresponding reportConfig; or
         if corresponding reportConfig includes reportType set to periodical:
         UE consider a neighbouring cell on the associated frequency to be applicable when the concerned cell is included in the cellsToAddModList defined within the VarMeasConfig for this measId;
      else if the corresponding measObject concerns L2 U2N Relay UE:
         if eventY1-Relay or eventY2-Relay or eventZ1-Relay is configured in the corresponding reportConfig; or
         if corresponding reportConfig includes reportType set to periodical:
         UE consider any L2 U2N Relay UE fulfilling upper layer criteria detected on the associated frequency to be applicable for this measId;
   else if the corresponding reportConfig includes a reportType set to reportCGL:
      UE consider the cell detected on the associated measObject which has a physical cell identity matching the value of the cellForWhichToReportCGI included in the corresponding reportConfig within the VarMeasConfig to be applicable;
   else if the corresponding reportConfig includes a reportType set to reportSFTD:
      if the corresponding measObject concerns NR:
         if the reportSFTD-Meas is set to true:
         UE consider the NR PSCell to be applicable;
         else if the reportSFTD-NeighMeas is included:
         if cellsForWhichToReportSFTD is configured in the corresponding reportConfig:
         UE consider any NR neighbouring cell detected on the associated measObjectNR which has a physical cell identity that is included in the cellsForWhichToReportSFTD to be applicable;
         else:
         UE consider up to 3 strongest NR neighbouring cells detected based on parameters in the associated measObjectNR to be applicable when the concerned cells are not included in the excludedCellsToAddModList defined within the VarMeasConfig for this measId;
      else if the corresponding measObject concerns E-UTRA:
         if the reportSFTD-Meas is set to true:
         UE consider the E-UTRA PSCell to be applicable;
   else if the corresponding reportConfig includes a reportType set to cli-Periodical or cli-EventTriggered:
      UE consider all CLI measurement resources included in the corresponding measObject to be applicable;
   else if the corresponding reportConfig includes a reportType set to rxTxPeriodical:
      UE consider all Rx-Tx time difference measurement resources included in the corresponding measObject to be applicable;
   if the corresponding reportConfig concerns the reporting for NR sidelink communication/discovery (i.e. reportConfigNR-SL):
      UE consider the transmission resource pools indicated by the tx-PoolMeasToAddModList defined within the VarMeasConfig for this measId to be applicable;
   if the reportType is set to eventTriggered, and if the corresponding reportConfig does not include numberOfTriggeringCells, and if the entry condition applicable for this event, i.e. the event corresponding with the eventId of the corresponding reportConfig within VarMeasConfig, is fulfilled for one or more applicable cells for all measurements after layer 3 filtering taken during timeToTrigger defined for this event within the VarMeasConfig, while the VarMeasReportList does not include a measurement reporting entry for this measId (a first cell triggers the event):
      UE include a measurement reporting entry within the VarMeasReportList for this measId;
      UE set the numberOfReportsSent defined within the VarMeasReportList for this measId to 0;
      UE include the concerned cell(s) in the cellsTriggeredList defined within the VarMeasReportList for this measId;
      if useT312 is set to true in reportConfig for this event:
         if T310 for the corresponding SpCell is running; and
         if T312 is not running for corresponding SpCell:
         UE start timer T312 for the corresponding SpCell with the value of T312 configured in the corresponding measObjectNR;
      UE initiate the measurement reporting procedure;
   if the reportType is set to eventTriggered, and if the corresponding reportConfig includes numberOfTriggeringCells, and if the entry condition applicable for this event, i.e. the event corresponding with the eventId of the corresponding reportConfig within VarMeasConfig, is fulfilled for one or more applicable cells for all measurements after layer 3 filtering taken during timeToTrigger defined for this event within the VarMeasConfig:
      if the VarMeasReportList does not include a measurement reporting entry for this measId (a first cell triggers the event):
         UE includes a measurement reporting entry within the VarMeasReportList for this measId;
      if the number of cell(s) in the cellsTriggeredList is larger than or equal to numberOfTriggeringCells:
         UE includes the concerned cell(s) in the cellsTriggeredList defined within the VarMeasReportList for this measId;
      else:
         UE includes the concerned cell(s) in the cellsTriggeredList defined within the VarMeasReportList for this measId;
         if the number of cell(s) in the cellsTriggeredList is larger than or equal to numberOfTriggeringCells:
         UE sets the numberOfReportsSent defined within the VarMeasReportList for this measId to 0;
         UE initiates the measurement reporting procedure;
   if the reportType is set to eventTriggered and if the leaving condition applicable for this event is fulfilled for one or more of the cells included in the cellsTriggeredList defined within the VarMeasReportList for this measId for all measurements after layer 3 filtering taken during timeToTrigger defined within the VarMeasConfig for this event:
      if enteringLeavingReport is configured for the corresponding report configuration:
         UE stores the concerned cell(s) in the cellsMetLeavingCond defined within the VarMeasReportList for this measId;
      UE removes the concerned cell(s) in the cellsTriggeredList defined within the VarMeasReportList for this measId;
      if reportOnLeave is set to true for the corresponding report configuration:
         if the corresponding reportConfig does not include numberOfTriggeringCells; or
         if the corresponding reportConfig includes numberOfTriggeringCells and a measurement report was previously sent to the network for at least one of the concerned cell(s):
         UE initiates the measurement reporting procedure;
      UE removes all the concerned cell(s) from cellsMetLeavingCond defined within the VarMeasReportList for this measId, if any;
      if the cellsTriggeredList defined within the VarMeasReportList for this measId is empty:
         UE removes the measurement reporting entry within the VarMeasReportList for this measId;
         UE stops the periodical reporting timer for this measId, if running;
   if the reportType is set to eventTriggered and if the entry condition applicable for this event, i.e. the event corresponding with the eventId of the corresponding reportConfig within VarMeasConfig, is fulfilled for one or more applicable L2 U2N Relay UEs for all measurements after layer 3 filtering taken during timeToTrigger defined for this event within the VarMeasConfig, while the VarMeasReportList does not include a measurement reporting entry for this measId (a first L2 U2N Relay UE triggers the event):
      UE includes a measurement reporting entry within the VarMeasReportList for this measId;
      UE sets the numberOfReportsSent defined within the VarMeasReportList for this measId to 0;
      UE includes the concerned L2 U2N Relay UE(s) in the relaysTriggeredList defined within the VarMeasReportList for this measId;
      UE initiates the measurement reporting procedure;
   else if the reportType is set to eventTriggered and if the entry condition applicable for this event, i.e. the event corresponding with the eventId of the corresponding reportConfig within VarMeasConfig, is fulfilled for one or more applicable L2 U2N Relay UEs not included in the relaysTriggeredList for all measurements after layer 3 filtering taken during timeToTrigger defined for this event within the VarMeasConfig (a subsequent L2 U2N Relay UE triggers the event):
      UE sets the numberOfReportsSent defined within the VarMeasReportList for this measId to 0;
      UE includes the concerned L2 U2N Relay UE(s) in the relaysTriggeredList defined within the VarMeasReportList for this measId;
      UE initiates the measurement reporting procedure;
   else if the reportType is set to eventTriggered and if the leaving condition applicable for this event is fulfilled for one or more of the L2 U2N Relay UEs included in the relaysTriggeredList defined within the VarMeasReportList for this measId for all measurements after layer 3 filtering taken during timeToTrigger defined within the VarMeasConfig for this event:
      UE removes the concerned L2 U2N Relay UE(s) in the relaysTriggeredList defined within the VarMeasReportList for this measId;
      if reportOnLeave is set to true for the corresponding report configuration:
         UE initiates the measurement reporting procedure;
      if the relaysTriggeredList defined within the VarMeasReportList for this measId is empty:
         UE removes the measurement reporting entry within the VarMeasReportList for this measId;
         UE stops the periodical reporting timer for this measId, if running;
   else if the reportType is set to eventTriggered and if the entry condition applicable for this event, i.e. the event corresponding with the eventId of the corresponding reportConfig within VarMeasConfig, is fulfilled for one or more applicable transmission resource pools for all measurements taken during timeToTrigger defined for this event within the VarMeasConfig, while the VarMeasReportList does not include an measurement reporting entry for this measId (a first transmission resource pool triggers the event):
      UE includes a measurement reporting entry within the VarMeasReportList for this measId;
      UE sets the numberOfReportsSent defined within the VarMeasReportList for this measId to 0;
      UE includes the concerned transmission resource pool(s) in the poolsTriggeredList defined within the VarMeasReportList for this measId;
      UE initiates the measurement reporting procedure;
   else if the reportType is set to eventTriggered and if the entry condition applicable for this event, i.e. the event corresponding with the eventId of the corresponding reportConfig within VarMeasConfig, is fulfilled for one or more applicable transmission resource pools not included in the poolsTriggeredList for all measurements taken during timeToTrigger defined for this event within the VarMeasConfig (a subsequent transmission resource pool triggers the event):
      UE sets the numberOfReportsSent defined within the VarMeasReportList for this measId to 0;
      UE includes the concerned transmission resource pool(s) in the poolsTriggeredList defined within the VarMeasReportList for this measId;
      UE initiates the measurement reporting procedure;
   if the reportType is set to eventTriggered and if the leaving condition applicable for this event is fulfilled for one or more applicable transmission resource pools included in the poolsTriggeredList defined within the VarMeasReportList for this measId for all measurements taken during timeToTrigger defined within the VarMeasConfig for this event:
      UE removes the concerned transmission resource pool(s) in the poolsTriggeredList defined within the VarMeasReportList for this measId;
      if the poolsTriggeredList defined within the VarMeasReportList for this measId is empty:
         UE removes the measurement reporting entry within the VarMeasReportList for this measId;
         UE stops the periodical reporting timer for this measId, if running
   else if the reportType is set to eventTriggered and if the eventId is set to eventD1 or eventD2 or eventH1 or eventH2 and if the entering condition applicable for this event, i.e. the event corresponding with the eventId of the corresponding reportConfig within VarMeasConfig, is fulfilled during timeToTrigger defined for this event within the VarMeasConfig, while the VarMeasReportList does not include a measurement reporting entry for this measId:
      UE includes a measurement reporting entry within the VarMeasReportList for this measId;
      UE sets the numberOfReportsSent defined within the VarMeasReportList for this measId to 0;
      UE initiates the measurement reporting procedure;
   else if the reportType is set to eventTriggered and if the eventId is set to eventD1 or eventD2 or eventH1 or eventH2 and if the leaving condition applicable for this event is fulfilled for the associated VarMeasReport within the VarMeasReportList for this measId during timeToTrigger defined within the VarMeasConfig for this event:
      if reportOnLeave is set to true for the corresponding reporting configuration:
         UE initiates the measurement reporting procedure;
      UE removes the measurement reporting entry within the VarMeasReportList for this measId;
      UE stops the periodical reporting timer for this measId, if running;
   if reportType is set to periodical and if a (first) measurement result is available:
      UE includes a measurement reporting entry within the VarMeasReportList for this measId;
      UE sets the numberOfReportsSent defined within the VarMeasReportList for this measId to 0;
      if the corresponding reportConfig includes measRSSI-ReportConfig:
         UE initiates the measurement reporting procedure immediately when RSSI sample values are reported by the physical layer after the first L1 measurement duration;
      else if the corresponding reportConfig includes the ul-DelayValueConfig:
         UE initiates the measurement reporting procedure, immediately after a first measurement result is provided from lower layers of the associated DRB identity;
      else if the corresponding reportConfig includes the ul-ExcessDelayConfig:
         UE initiates the measurement reporting procedure, immediately after a first measurement result is provided from lower layers of the associated DRB identity(ies) according to the configured threshold per DRB identity(ies);
      else if the reportAmount exceeds 1:
         UE initiates the measurement reporting procedure, immediately after the quantity to be reported becomes available for the NR SpCell or for the serving L2 U2N Relay UE (if the UE is a L2 U2N Remote UE);
      else (i.e. the reportAmount is equal to 1):
         UE initiates the measurement reporting procedure, immediately after the quantity to be reported becomes available for the NR SpCell and for the strongest cell among the applicable cells, or for the NR SpCell and for the strongest L2 U2N Relay UEs among the applicable L2 U2N Relay UEs; or initiate the measurement reporting procedure, immediately after the quantity to be reported becomes available for the serving L2 U2N Relay UE and for the strongest cell among the applicable cells, or for the serving L2 U2N Relay UE and for the strongest L2 U2N Relay UEs among the applicable L2 U2N Relay UEs (if the UE is a L2 U2N Remote UE);
   if, in case the corresponding reportConfig concerns the reporting for NR sidelink communication/discovery, reportType is set to periodical and if a (first) measurement result is available:
      UE includes a measurement reporting entry within the VarMeasReportList for this measId;
      UE sets the numberOfReportsSent defined within the VarMeasReportList for this measId to 0;
      UE initiates the measurement reporting procedure, immediately after the quantity to be reported becomes available for the NR SpCell and CBR measurement results become available;
   if the reportType is set to cli-EventTriggered and if the entry condition applicable for this event, i.e. the event corresponding with the eventId of the corresponding reportConfig within VarMeasConfig, is fulfilled for one or more applicable CLI measurement resources for all measurements after layer 3 filtering taken during timeToTrigger defined for this event within the VarMeasConfig, while the VarMeasReportList does not include a measurement reporting entry for this measId (a first CLI measurement resource triggers the event):
      UE includes a measurement reporting entry within the VarMeasReportList for this measId;
      UE sets the numberOfReportsSent defined within the VarMeasReportList for this measId to 0;
      UE includes the concerned CLI measurement resource(s) in the cli-TriggeredList defined within the VarMeasReportList for this measId;
      UE initiates the measurement reporting procedure;
   else if the reportType is set to cli-EventTriggered and if the entry condition applicable for this event, i.e. the event corresponding with the eventId of the corresponding reportConfig within VarMeasConfig, is fulfilled for one or more CLI measurement resources not included in the cli-TriggeredList for all measurements after layer 3 filtering taken during timeToTrigger defined for this event within the VarMeasConfig (a subsequent CLI measurement resource triggers the event):
      UE sets the numberOfReportsSent defined within the VarMeasReportList for this measId to 0;
      UE includes the concerned CLI measurement resource(s) in the cli-TriggeredList defined within the VarMeasReportList for this measId;
      UE initiates the measurement reporting procedure;
   if the reportType is set to cli-EventTriggered and if the leaving condition applicable for this event is fulfilled for one or more of the CLI measurement resources included in the cli-TriggeredList defined within the VarMeasReportList for this measId for all measurements after layer 3 filtering taken during timeToTrigger defined within the VarMeasConfig for this event:
      UE removes the concerned CLI measurement resource(s) in the cli-TriggeredList defined within the VarMeasReportList for this measId;
      if reportOnLeave is set to true for the corresponding reporting configuration:
         UE initiates the measurement reporting procedure;
      if the cli-TriggeredList defined within the VarMeasReportList for this measId is empty:
         UE removes the measurement reporting entry within the VarMeasReportList for this measId;
         UE stops the periodical reporting timer for this measId, if running;
   if reportType is set to cli-Periodical and if a (first) measurement result is available:
      UE includes a measurement reporting entry within the VarMeasReportList for this measId;
      UE sets the numberOfReportsSent defined within the VarMeasReportList for this measId to 0;
      UE initiates the measurement reporting procedure, immediately after the quantity to be reported becomes available for at least one CLI measurement resource;
   if reportType is set to rxTxPeriodical and if a (first) measurement result is available:
      UE includes a measurement reporting entry within the VarMeasReportList for this measId;
      UE sets the numberOfReportsSent defined within the VarMeasReportList for this measId to 0;
      UE initiates the measurement reporting procedure;
   upon expiry of the periodical reporting timer for this measId:
      if reportType is set to eventTriggered and reportOnBestCellChange is configured for this measId
         if reportOnBestCellChange is set to n1, and the first measured neighbouring cell among cells within cellsTriggeredList according to the sorting quantity is the same as the first cell in reportedBestNeighbourCell defined within the VarMeasReportList for this measId, or
         if reportOnBestCellChange is set to n2 and there is only one cell included in the cellsTriggeredList for this measId, and the best measured neighbouring cell according to the sorting quantity in the cellsTriggeredList is the same as the first cell in reportedBestNeighbourCell defined within the VarMeasReportList for this measId, or
         if reportOnBestCellChange is set to n2 and there is more than one cell included in the cellsTriggeredList for this measId, and the best measured neighbouring cell among cells within cellsTriggeredList according to the sorting quantity is the same as the first cell in reportedBestNeighbourCell defined within the VarMeasReportList for this measId, and the second best measured neighbouring cell among cells within cellsTriggeredList according to the sorting quantity is the same as the second cell in reportedBestNeighbourCell defined within the VarMeasReportList for this measId:
         UE increments the numberOfReportsSent as defined within the VarMeasReportList for this measId by 1;
         if the numberOfReportsSent as defined within the VarMeasReportList for this measId is less than the reportAmount as defined within the corresponding reportConfig for this measId:
         restart the periodical reporting timer with the value of reportInterval as defined within the corresponding reportConfig for this measId;
         else:
         UE initiates the measurement reporting procedure;
      else:
         UE initiates the measurement reporting procedure.
   if the corresponding reportConfig includes a reportType is set to reportSFTD:
      if the corresponding measObject concerns NR:
         if the drx-SFTD-NeighMeas is included:
         if the quantity to be reported becomes available for each requested pair of PCell and NR cell:
         UE stops timer T322;
         UE initiates the measurement reporting procedure;
         else
         UE initiates the measurement reporting procedure, immediately after the quantity to be reported becomes available for each requested pair of PCell and NR cell or the maximal measurement reporting delay;
      else if the corresponding measObject concerns E-UTRA:
         UE initiates the measurement reporting procedure, immediately after the quantity to be reported becomes available for the pair of PCell and E-UTRA PSCell or the maximal measurement reporting delay;
   if reportType is set to reportCGL:
      if the UE acquired the SIB1 or SystemInformationBlockType1 for the requested cell; or
      if the UE detects that the requested NR cell is not transmitting SIB1 (see TS 38.213 [13], clause 13):
         UE stops timer T321;
         UE includes a measurement reporting entry within the VarMeasReportList for this measId;
         UE sets the numberOfReportsSent defined within the VarMeasReportList for this measId to 0;
         UE initiates the measurement reporting procedure;
   upon the expiry of T321 for this measId:
      UE includes a measurement reporting entry within the VarMeasReportList for this measId;
      UE sets the numberOfReportsSent defined within the VarMeasReportList for this measId to 0;
      UE initiates the measurement reporting procedure.
   upon the expiry of T322 for this measId:
      UE initiates the measurement reporting procedure.

For Event A1, the UE shall:
consider the entering condition for this event to be satisfied when condition A1-1, as specified below, is fulfilled;
consider the leaving condition for this event to be satisfied when condition A1-2, as specified below, is fulfilled;
for this measurement, consider the NR serving cell corresponding to the associated measObjectNR associated with this event.

$$Inequality A 1 - 1 ( Entering condition ) \\ Ms - Hys > Thresh \\ Inequality A 1 - 2 ( Leaving condition ) \\ Ms + Hys < Thresh$$

The variables in the formula are defined as follows:
Ms is the measurement result of the serving cell, not taking into account any offsets.
Hys is the hysteresis parameter for this event (i.e. hysteresis as defined within reportConfigNR for this event).
Thresh is the threshold parameter for this event (i.e. a1-Threshold as defined within reportConfigNR for this event).
Ms is expressed in dBm in case of RSRP, or in dB in case of RSRQ and RS-SINR.
Hys is expressed in dB.
Thresh is expressed in the same unit as Ms.

For Event A2 (Serving becomes worse than threshold), The UE shall:
consider the entering condition for this event to be satisfied when condition A2-1, as specified below, is fulfilled;
consider the leaving condition for this event to be satisfied when condition A2-2, as specified below, is fulfilled;
for this measurement, consider the serving cell indicated by the measObjectNR associated to this event.

$$Inequality A 2 - 1 ( Entering condition ) \\ Ms + Hys < Thresh \\ Inequality A 2 - 2 ( Leaving condition ) \\ Ms - Hys > Thresh$$

The variables in the formula are defined as follows:
Ms is the measurement result of the serving cell, not taking into account any offsets.
Hys is the hysteresis parameter for this event (i.e. hysteresis as defined within reportConfigNR for this event).
Thresh is the threshold parameter for this event (i.e. a2-Threshold as defined within reportConfigNR for this event).
Ms is expressed in dBm in case of RSRP, or in dB in case of RSRQ and RS-SINR.
Hys is expressed in dB.
Thresh is expressed in the same unit as Ms.

For Event A3 (Neighbour becomes offset better than SpCell), the UE shall:
consider the entering condition for this event to be satisfied when condition A3-1, as specified below, is fulfilled;
consider the leaving condition for this event to be satisfied when condition A3-2, as specified below, is fulfilled;
use the SpCell for Mp, Ofp and Ocp.

$$Inequality A 3 - 1 ( Entering condition ) \\ Mn + Ofn + Ocn - Hys > Mp + Ofp + Ocp + Off \\ Inequality A 3 - 2 ( Leaving condition ) \\ Mn + Ofn + Ocn + Hys < Mp + Ofp + Ocp + Off$$

The variables in the formula are defined as follows:
Mn is the measurement result of the neighbouring cell, not taking into account any offsets.
Ofn is the measurement object specific offset of the reference signal of the neighbour cell (i.e. offsetMO as defined within measObjectNR corresponding to the neighbour cell).
Ocn is the cell specific offset of the neighbour cell (i.e. cellIndividualOffset as defined within measObjectNR corresponding to the frequency of the neighbour cell, or cellIndividualOffset as defined within reportConfigNR), and set to zero if not configured for the neighbour cell.
Mp is the measurement result of the SpCell, not taking into account any offsets.
Ofp is the measurement object specific offset of the SpCell (i.e. offsetMO as defined within measObjectNR corresponding to the SpCell).
Ocp is the cell specific offset of the SpCell (i.e. cellIndividualOffset as defined within measObjectNR corresponding to the SpCell), and is set to zero if not configured for the SpCell.
Hys is the hysteresis parameter for this event (i.e. hysteresis as defined within reportConfigNR for this event).
Off is the offset parameter for this event (i.e. a3-Offset as defined within reportConfigNR for this event).
Mn, Mp are expressed in dBm in case of RSRP, or in dB in case of RSRQ and RS-SINR.
Ofn, Ocn, Ofp, Ocp, Hys, Off are expressed in dB.

For Event A4 (Neighbour becomes better than threshold), the UE shall:
consider the entering condition for this event to be satisfied when condition A4-1, as specified below, is fulfilled;
consider the leaving condition for this event to be satisfied when condition A4-2, as specified below, is fulfilled.

$$Inequality A 4 - 1 ( Entering condition ) \\ Mn + Ofn + Ocn - Hys > Thresh \\ Inequality A 4 - 2 ( Leaving condition ) \\ Mn + Ofn + Ocn + Hys < Thresh$$

The variables in the formula are defined as follows:
Mn is the measurement result of the neighbouring cell or the measurement result of serving PSCell (i.e., in case it is configured as candidate PSCell for CondEvent A4 evaluation) for CHO with candidate SCG(s) case, not taking into account any offsets.
Ofn is the measurement object specific offset of the neighbour cell (i.e. offsetMO as defined within measObjectNR corresponding to the neighbour cell).
Ocn is the measurement object specific offset of the neighbour cell (i.e. cellIndividualOffset as defined within measObjectNR corresponding to the neighbour cell, or cellIndividualOffset as defined within reportConfigNR), and set to zero if not configured for the neighbour cell.
Hys is the hysteresis parameter for this event (i.e. hysteresis as defined within reportConfigNR for this event).
Thresh is the threshold parameter for this event (i.e. a4-Threshold as defined within reportConfigNR for this event).
Mn is expressed in dBm in case of RSRP, or in dB in case of RSRQ and RS-SINR.
Ofn, Ocn, Hys are expressed in dB.
Thresh is expressed in the same unit as Mn.

For Event A5 (SpCell becomes worse than threshold1 and neighbour becomes better than threshold2), the UE shall:
consider the entering condition for this event to be satisfied when both condition A5-1 and condition A5-2, as specified below, are fulfilled;
consider the leaving condition for this event to be satisfied when condition A5-3 or condition A5-4, i.e. at least one of the two, as specified below, is fulfilled;
use the SpCell for Mp.

The parameters of the reference signal(s) of the cell(s) that triggers the event are indicated in the measObjectNR associated to the event which may be different from the measObjectNR of the NR SpCell.

$$Inequality A 5 - 1 ( Entering condition 1 ) \\ Mp + Hys < Thresh 1$$

$$Inequality A 5 - 2 ( Entering condition 2 ) \\ Mn + Ofn + Ocn - Hys > Thresh 2$$

$$Inequality A 5 - 3 ( Leaving condition 1 ) \\ Mp - Hys > Thresh 1$$

$$Inequality A 5 - 4 ( Leaving condition 2 ) \\ Mn + Ofn + Ocn + Hys < Thresh 2$$

The variables in the formula are defined as follows:
Mp is the measurement result of the NR SpCell, not taking into account any offsets.
Mn is the measurement result of the neighbouring cell, not taking into account any offsets.
Ofn is the measurement object specific offset of the neighbour cell (i.e. offsetMO as defined within measObjectNR corresponding to the neighbour cell).
Ocn is the cell specific offset of the neighbour cell (i.e. cellIndividualOffset as defined within measObjectNR corresponding to the neighbour cell, or cellIndividualOffset as defined within reportConfigNR), and set to zero if not configured for the neighbour cell.
Hys is the hysteresis parameter for this event (i.e. hysteresis as defined within reportConfigNR for this event).
Thresh1 is the threshold parameter for this event (i.e. a5-Threshold1 as defined within reportConfigNR for this event).
Thresh2 is the threshold parameter for this event (i.e. a5-Threshold2 as defined within reportConfigNR for this event).
Mn, Mp are expressed in dBm in case of RSRP, or in dB in case of RSRQ and RS-SINR.
Ofn, Ocn, Hys are expressed in dB.
Thresh1 is expressed in the same unit as Mp.
Thresh2 is expressed in the same unit as Mn.

For Event A6 (Neighbour becomes offset better than SCell), the UE shall:
consider the entering condition for this event to be satisfied when condition A6-1, as specified below, is fulfilled;
consider the leaving condition for this event to be satisfied when condition A6-2, as specified below, is fulfilled;
for this measurement, consider the (secondary) cell corresponding to the measObjectNR associated to this event to be the serving cell.

NOTE: The reference signal(s) of the neighbour(s) and the reference signal(s) of the SCell are both indicated in the associated measObjectNR.

$$Inequality A 6 - 1 ( Entering condition ) \\ Mn + Ocn - Hys > M s + Ocs + Off \\ Inequality A 6 - 2 ( Leaving condition ) \\ Mn + Ocn + Hys < Ms + Ocs + Off$$

The variables in the formula are defined as follows:
Mn is the measurement result of the neighbouring cell, not taking into account any offsets.
Ocn is the cell specific offset of the neighbour cell (i.e. cellIndividualOffset as defined within the associated measObjectNR), and set to zero if not configured for the neighbour cell.
Ms is the measurement result of the serving cell, not taking into account any offsets.
Ocs is the cell specific offset of the serving cell (i.e. cellIndividualOffset as defined within the associated measObjectNR, or cellIndividualOffset as defined within reportConfigNR), and is set to zero if not configured for the serving cell.
Hys is the hysteresis parameter for this event (i.e. hysteresis as defined within reportConfigNR for this event).
Off is the offset parameter for this event (i.e. a6-Offset as defined within reportConfigNR for this event).
Mn, Ms are expressed in dBm in case of RSRP, or in dB in case of RSRQ and RS-SINR.
Ocn, Ocs, Hys, Off are expressed in dB.

For Event D1 (Distance between UE and referenceLocation1 is above threshold1 and distance between UE and referenceLocation2 is below threshold2), The UE shall:
consider the entering condition for this event to be satisfied when both condition D1-1 and condition D1-2, as specified below, are fulfilled;
consider the leaving condition for this event to be satisfied when condition D1-3 or condition D1-4, i.e. at least one of the two, as specified below, are fulfilled;

$$Inequality D 1 - 1 ( Entering condition 1 ) Ml 1 - Hys > Thresh 1$$

$$Inequality D 1 - 2 ( Entering condition 2 ) Ml 2 + Hys < Thresh 2$$

$$Inequality D 1 - 3 ( Leaving condition 1 ) Ml 1 + Hys < Thresh 1$$

$$Inequality D 1 - 4 ( Leaving condition 2 ) Ml 2 - Hys > Thresh 2$$

The variables in the formula are defined as follows:
Ml1 is the distance between UE and a reference location for this event (i.e. referenceLocation1 as defined within reportConfigNR for this event), not taking into account any offsets.
Ml2 is the distance between UE and a reference location for this event (i.e. referenceLocation2 as defined within reportConfigNR for this event), not taking into account any offsets.
Hys is the hysteresis parameter for this event (i.e. hysteresisLocation as defined within reportConfigNR for this event).
Thresh1 is the threshold for this event defined as a distance, configured with parameter distanceThreshFromReference1, from a reference location configured with parameter referenceLocation1 within reportConfigNR for this event.
Thresh2 is the threshold for this event defined as a distance, configured with parameter distanceThreshFromReference2, from a reference location configured with parameter referenceLocation2 within reportConfigNR for this event.
Ml1 is expressed in meters.
Ml2 is expressed in the same unit as Ml1.
Hys is expressed in the same unit as Ml1.
Thresh1 is expressed in the same unit as Ml1.
Thresh2 is expressed in the same unit as Ml1.

NOTE: The definition of Event D1 also applies to CondEvent D1.

For Event D2 (Distance between UE and serving cell moving reference location is above threshold1 and distance between UE and a moving reference location is below threshold2), the UE shall:
consider the entering condition for this event to be satisfied when both condition D2-1 and condition D2-2, as specified below, are fulfilled;
consider the leaving condition for this event to be satisfied when condition D2-3 or condition D2-4, i.e. at least one of the two, as specified below, are fulfilled;

$$Inequality D 2 - 1 ( Entering condition 1 ) Ml 1 - Hys > Thresh 1$$

$$Inequality D 2 - 2 ( Entering condition 2 ) Ml 2 + Hys < Thresh 2$$

$$Inequality D 2 - 3 ( Leaving condition 1 ) Ml 1 + Hys < Thresh 1$$

$$Inequality D 2 - 4 ( Leaving condition 2 ) Ml 2 - Hys > Thresh 2$$

The variables in the formula are defined as follows:
Ml1 is the distance between UE and a moving reference location for this event, not taking into account any offsets. The moving reference location is determined based on movingReferenceLocation and the corresponding epoch time and satellite ephemeris for the serving cell broadcast in SIB19.
Ml2 is the distance between UE and a moving reference location for this event, not taking into account any offsets. The moving reference location is determined based on referenceLocation2 as defined within reportConfigNR for this event and the corresponding epoch time and satellite ephemeris for the candidate cell.
Hys is the hysteresis parameter for this event (i.e. hysteresisLocation as defined within reportConfigNR for this event).
Thresh1 is the threshold for this event defined as a distance, configured with parameter distanceThreshFromReference1 in reportConfigNR for this event, from a moving reference location derived based on the parameter movingReferenceLocation within SIB19.
Thresh2 is the threshold for this event defined as a distance, configured with parameter distanceThreshFromReference2, from a moving reference location derived based on the parameter referenceLocation2 within reportConfigNR for this event.
Ml1 is expressed in meters.
Ml2 is expressed in the same unit as Ml1.
Hys is expressed in the same unit as Ml1.
Thresh1 is expressed in the same unit as Ml1.
Thresh2 is expressed in the same unit as Ml1.

For the measId for which the measurement reporting procedure was triggered, the UE shall set the measResults within the MeasurementReport message as follows:
UE set the measId to the measurement identity that triggered the measurement reporting;
for each serving cell configured with servingCellMO:
   if the reportConfig associated with the measId that triggered the measurement reporting includes rsType:
      if the serving cell measurements based on the rsType included in the reportConfig that triggered the measurement report are available:
         UE set the measResultServingCell within measResultServingMOList to include RSRP, RSRQ and the available SINR of the serving cell, derived based on the rsType included in the reportConfig that triggered the measurement report;
   else:
      if SSB based serving cell measurements are available:
         UE set the measResultServingCell within measResultServingMOList to include RSRP, RSRQ and the available SINR of the serving cell, derived based on SSB;
      else if CSI-RS based serving cell measurements are available:
         UE set the measResultServingCell within measResultServingMOList to include RSRP, RSRQ and the available SINR of the serving cell, derived based on CSI-RS;
UE set the servCellId within measResultServingMOList to include each NR serving cell that is configured with servingCellMO, if any;
if the reportConfig associated with the measId that triggered the measurement reporting includes reportQuantityRS-Indexes and maxNrofRS-IndexesToReport:
   for each serving cell configured with servingCellMO, UE include beam measurement information according to the associated reportConfig
if the reportConfig associated with the measId that triggered the measurement reporting includes reportAddNeighMeas:
   for each measObjectId referenced in the measIdList which is also referenced with servingCellMO, other than the measObjectId corresponding with the measId that triggered the measurement reporting:
      if the measObjectNR indicated by the servingCellMO includes the RS resource configuration corresponding to the rsType indicated in the reportConfig:
         UE set the measResultBestNeighCell within measResultServingMOList to include the physCellId and the available measurement quantities based on the reportQuantityCell and rsType indicated in reportConfig of the non-serving cell corresponding to the concerned measObjectNR with the highest measured RSRP if RSRP measurement results are available for cells corresponding to this measObjectNR, otherwise with the highest measured RSRQ if RSRQ measurement results are available for cells corresponding to this measObjectNR, otherwise with the highest measured SINR;
         if the reportConfig associated with the measId that triggered the measurement reporting includes reportQuantityRS-Indexes and maxNrofRS-IndexesToReport:
         for each best non-serving cell included in the measurement report:
         UE include beam measurement information according to the associated reportConfig;
if the reportConfig associated with the measId that triggered the measurement reporting is set to eventTriggered and eventID is set to eventA3, or eventA4, or eventA5, or eventB1, or eventB2, or eventA3H1, or eventA3H2, or eventA4H1, or eventA4H2, or eventA5H1, or eventA5H2:
   if the UE is in NE-DC and the measurement configuration that triggered this measurement report is associated with the MCG:
      UE set the measResultServFreqListEUTRA-SCG to include an entry for each E-UTRA SCG serving frequency with the following:
         UE include carrierFreq of the E-UTRA serving frequency;
         UE set the measResultServingCell to include the available measurement quantities that the UE is configured to measure by the measurement configuration associated with the SCG;
         if reportConfig associated with the measId that triggered the measurement reporting includes reportAddNeighMeas:
         UE set the measResultServFreqListEUTRA-SCG to include within measResultBestNeighCell the quantities of the best non-serving cell, based on RSRP, on the concerned serving frequency;
if reportConfig associated with the measId that triggered the measurement reporting is set to eventTriggered and eventID is set to eventA3, or eventA4, or eventA5, or eventA3H1, or eventA3H2, or eventA4H1, or eventA4H2, or eventA5H1, or eventA5H2:
   if the UE is in NR-DC and the measurement configuration that triggered this measurement report is associated with the MCG:
      UE set the measResultServFreqListNR-SCG to include for each NR SCG serving cell that is configured with servingCellMO, if any, the following:
         if the reportConfig associated with the measId that triggered the measurement reporting includes rsType:
         if the serving cell measurements based on the rsType included in the reportConfig that triggered the measurement report are available according to the measurement configuration associated with the SCG:
         UE set the measResultServingCell within measResultServFreqListNR-SCG to include RSRP, RSRQ and the available SINR of the serving cell, derived based on the rsType included in the reportConfig that triggered the measurement report;
         else:
         if SSB based serving cell measurements are available according to the measurement configuration associated with the SCG:
         UE set the measResultServingCell within measResultServFreqListNR-SCG to include RSRP, RSRQ and the available SINR of the serving cell, derived based on SSB;
         else if CSI-RS based serving cell measurements are available according to the measurement configuration associated with the SCG:
         UE set the measResultServingCell within measResultServFreqListNR-SCG to include RSRP, RSRQ and the available SINR of the serving cell, derived based on CSI-RS;
         if results for the serving cell derived based on SSB are included:
         UE include the ssbFrequency to the value indicated by ssbFrequency as included in the MeasObjectNR of the serving cell;
         if results for the serving cell derived based on CSI-RS are included:
         UE include the refFreqCSI-RS to the value indicated by refFreqCSI-RS as included in the MeasObjectNR of the serving cell;
         if the reportConfig associated with the measId that triggered the measurement reporting includes reportQuantityRS-Indexes and maxNrofRS-IndexesToReport:
         for each serving cell configured with servingCellMO, UE include beam measurement information according to the associated reportConfig, where availability is considered according to the measurement configuration associated with the SCG;
         if reportConfig associated with the measId that triggered the measurement reporting includes reportAddNeighMeas:
         if the measObjectNR indicated by the servingCellMO includes the RS resource configuration corresponding to the rsType indicated in the reportConfig:
         UE set the measResultNeighCellListNR within measResultServFreqListNR-SCG to include one entry with the physCellId and the available measurement quantities based on the reportQuantityCell and rsType indicated in reportConfig of the non-serving cell corresponding to the concerned measObjectNR with the highest measured RSRP if RSRP measurement results are available for cells corresponding to this measObjectNR, otherwise with the highest measured RSRQ if RSRQ measurement results are available for cells corresponding to this measObjectNR, otherwise with the highest measured SINR, where availability is considered according to the measurement configuration associated with the SCG;
         if the reportConfig associated with the measId that triggered the measurement reporting includes reportQuantityRS-Indexes and maxNrofRS-IndexesToReport:
         for each best non-serving cell included in the measurement report:
         UE include beam measurement information according to the associated reportConfig, where availability is considered according to the measurement configuration associated with the SCG;
if the measRSSI-ReportConfig is configured within the corresponding reportConfig for this measId:
   UE set the rssi-Result to the linear average of sample value(s) provided by lower layers in the reportInterval;
   UE set the channelOccupancy to the rounded percentage of sample values which are beyond the channelOccupancyThreshold within all the sample values in the reportInterval;
if the UE is acting as L2 U2N Remote UE:
   UE set the sl-MeasResultServingRelay in accordance with the following:
      UE set the cellIdentity to include the cellAccessRelatedInfo contained in the discovery message received from the serving L2 U2N Relay UE;
      UE set the sl-RelayUE-Identity to include the Source L2 ID of the serving L2 U2N Relay;
      if the measurement of serving L2 U2N Relay UE is based on SL-RSRP:
         UE set the sl-MeasResult to include the SL-RSRP of the serving L2 U2N Relay UE;
         UE set the sl-MeasQuantity to sl-rsrp, if supported by the UE;
      else:
         UE set the sl-MeasResult to include the SD-RSRP of the serving L2 U2N Relay UE;
UE set the sl-MeasQuantity to sd-rsrp, if supported by the UE;

In case of no data transmission from L2 U2N Relay UE to L2 U2N Remote UE, it is left to UE implementation whether to use SL-RSRP or SD-RSRP when setting the sl-MeasResultServingRelay of the serving L2 U2N Relay UE.
if there is at least one applicable neighbouring cell or candidate L2 U2N Relay UE to report:
   if the reportType is set to eventTriggered or periodical:
      if the measurement report concerns the candidate L2 U2N Relay UE:
         UE set the sl-MeasResultsCandRelay in measResultNeighCells to include the best candidate L2 U2N Relay UEs up to maxNrofRelayMeas in accordance with the following:
         if the reportType is set to eventTriggered:
         UE include the L2 U2N Relay UEs included in the relaysTriggeredList as defined within the VarMeasReportList for this measId;
         else:
         UE include the applicable L2 U2N Relay UEs for which the new measurement results became available since the last periodical reporting or since the measurement was initiated or reset;
         for each L2 U2N Relay UE that is included in the sl-MeasResultsCandRelay:
         UE set the cellIdentity to include the cellAccessRelatedInfo contained in the discovery message received from the concerned L2 U2N Relay UE;
         UE set the sl-RelayUE-Identity to include the Source L2 ID of the concerned L2 U2N Relay UE;
         UE set the sl-MeasResult to include the SD-RSRP of the concerned L2 U2N Relay UE;
         for each included L2 U2N Relay UE, include the layer 3 filtered measured results in accordance with the reportConfig for this measId, ordered as follows:
         UE set the sl-MeasResult to include the quantity(ies) indicated in the reportQuantityRelay within the concerned reportConfigRelay in decreasing order of the sorting quantity, determined.3, i.e. the best L2 U2N Relay UE is included first;
         if the UE supports multipathRemoteUE-PC5L2 and idle/inactive relay UE reporting, and if the sl-RelaylndicationMP is contained in the discovery message received from the concerned L2 U2N Relay UE:
         UE set the sl-RelaylndicationMP in the sl-MeasResultsCandRelay;
      else:
         UE set the measResultNeighCells to include the best neighbouring cells up to maxReportCells in accordance with the following:
         if the reportType is set to eventTriggered and eventId is not set to eventD1 or eventD2 or eventH1 or eventH2:
         UE include the cells included in the cellsTriggeredList as defined within the VarMeasReportList for this measId;
         else:
         UE include the applicable cells for which the new measurement results became available since the last periodical reporting or since the measurement was initiated or reset;
         for each cell that is included in the measResultNeighCells, include the physCellId;
         if the reportType is set to eventTriggered or periodical:
         for each included cell, include the layer 3 filtered measured results in accordance with the reportConfig for this measId, ordered as follows:
         if the measObject associated with this measId concerns NR:
         : if rsType in the associated reportConfig is set to ssb:
         UE set resultsSSB-Cell within the measResult to include the SS/PBCH block based quantity(ies) indicated in the reportQuantityCell within the concerned reportConfig, in decreasing order of the sorting quantity, determined.3, i.e. the best cell is included first;
         if reportQuantityRS-Indexes and maxNrofRS-IndexesToReport are configured, include beam measurement information;
         else if rsType in the associated reportConfig is set to csi-rs:
         UE set resultsCSI-RS-Cell within the measResult to include the CSI-RS based quantity(ies) indicated in the reportQuantityCell within the concerned reportConfig, in decreasing order of the sorting quantity, determined.3, i.e. the best cell is included first;
         if reportQuantityRS-Indexes and maxNrofRS-IndexesToReport are configured, include beam measurement information;
         if the measObject associated with this measId concerns E-UTRA:
         UE set the measResult to include the quantity(ies) indicated in the reportQuantity within the concerned reportConfigInterRAT in decreasing order of the sorting quantity, determined.3, i.e. the best cell is included first;
         if the measObject associated with this measId concerns UTRA-FDD and if ReportConfigInterRAT includes the reportQuantityUTRA-FDD:
         : UE set the measResult to include the quantity(ies) indicated in the reportQuantityUTRA-FDD within the concerned reportConfigInterRAT in decreasing order of the sorting quantity, determined.3, i.e. the best cell is included first;
   else:
      if the cell indicated by cellForWhichToReportCGI is an NR cell:
         if plmn-IdentityInfoList of the cgi-Info for the concerned cell has been obtained:
         UE include the plmn-IdentityInfoList including plmn-IdentityList, trackingAreaCode (if available), trackingAreaList (if available), ranac (if available), cellIdentity and cellReservedForOperatorUse for each entry of the plmn-IdentityInfoList;
         UE include frequencyBandList if available;
         for each PLMN-IdentityInfo in plmn-IdentityInfoList:
         if the gNB-ID-Length is broadcast:
         UE include gNB-ID-Length;
         if nr-CGI-Reporting-NPN is supported by the UE and npn-IdentityInfoList of the cgi-Info for the concerned cell has been obtained:
         UE include the npn-IdentityInfoList including npn-IdentityList, trackingAreaCode, ranac (if available), cellIdentity and cellReservedForOperatorUse for each entry of the npn-IdentityInfoList;
         for each NPN-IdentityInfo in NPN-IdentityInfoList:
         if the gNB-ID-Length is broadcast:
         UE include gNB-ID-Length;
         UE include cellReservedForOtherUse if available;
         else if MIB indicates the SIB1 is not broadcast:
         UE include the noSIB1 including the ssb-SubcarrierOffset and pdcch-ConfigSIB1 obtained from MIB of the concerned cell;
if the corresponding measObject concerns NR:
   if the reportSFTD-Meas is set to true within the corresponding reportConfigNR for this measId:
      UE set the measResultSFTD-NR in accordance with the following:
         UE set sfn-OffsetResult and frameBoundaryOffsetResult to the measurement results provided by lower layers;
         if the reportRSRP is set to true;
         UE set rsrp-Result to the RSRP of the NR PSCell derived based on SSB;
   else if the reportSFTD-NeighMeas is included within the corresponding reportConfigNR for this measId:
      for each applicable cell which measurement results are available, include an entry in the measResultCellListSFTD-NR and set the contents as follows:
         UE set physCellId to the physical cell identity of the concerned NR neighbour cell.
         UE set sfn-OffsetResult and frameBoundaryOffsetResult to the measurement results provided by lower layers;
         if the reportRSRP is set to true:
         UE set rsrp-Result to the RSRP of the concerned cell derived based on SSB;
else if the corresponding measObject concerns E-UTRA:
   if the reportSFTD-Meas is set to true within the corresponding reportConfigInterRAT for this measId:
      UE set the measResultSFTD-EUTRA in accordance with the following:
         UE set sfn-OffsetResult and frameBoundaryOffsetResult to the measurement results provided by lower layers;
         if the reportRSRP is set to true;
         UE set rsrpResult-EUTRA to the RSRP of the EUTRA PSCell;
if average uplink PDCP delay values are available:
   UE set the ul-PDCP-DelayValueResultList to include the corresponding average uplink PDCP delay values;
if PDCP excess delay measurements are available:
   UE set the ul-PDCP-ExcessDelayResultList to include the corresponding PDCP excess delay measurements;
if the includeCommonLocationInfo is configured in the corresponding reportConfig for this measId and detailed location information that has not been reported is available, set the content of commonLocationInfo of the locationInfo as follows:
   UE include the locationTimestamp;
   UE include the locationCoordinate, if available;
   UE include the velocityEstimate, if available;
   UE include the locationError, if available;
   UE include the locationSource, if available;
   if available, UE include the gnss-TOD-msec,
if the coarseLocationRequest is set to true in the corresponding reportConfig for this measId:
   UE include coarseLocationInfo, if available;
if the includeWLAN-Meas is configured in the corresponding reportConfig for this measId, set the wlan-LocationInfo of the locationInfo in the measResults as follows:
   if available, UE include the LogMeasResultWLAN, in order of decreasing RSSI for WLAN APs;
if the includeBT-Meas is configured in the corresponding reportConfig for this measId, set the BT-LocationInfo of the locationInfo in the measResults as follows:
   if available, UE include the LogMeasResultBT, in order of decreasing RSSI for Bluetooth beacons;
if the includeSensor-Meas is configured in the corresponding reportConfig for this measId, set the sensor-LocationInfo of the locationInfo in the measResults as follows:
   if available, UE include the sensor-MeasurementInformation;
   if available, UE include the sensor-MotionInformation;
if the includeAltitudeUE is set to true in the corresponding reportConfig for this measId:
   UE set the altitudeUE to include the altitude of the UE;
if there is at least one applicable transmission resource pool for NR sidelink communication/discovery (for measResultsSL):
   UE set the measResultsListSL to include the CBR measurement results in accordance with the following:
      if the reportType is set to eventTriggered:
         UE include the transmission resource pools included in the poolsTriggeredList as defined within the VarMeasReportList for this measId;
      else:
         UE include the applicable transmission resource pools for which the new measurement results became available since the last periodical reporting or since the measurement was initiated or reset;
      if the corresponding measObject concerns NR sidelink communication/discovery, then for each transmission resource pool to be reported:
         UE set the sl-poolReportIdentity to the identity of this transmission resource pool;
UE set the sl-CBR-ResultsNR to the CBR measurement results on PSSCH and PSCCH of this transmission resource pool provided by lower layers, if available;
UE increment the numberOfReportsSent as defined within the VarMeasReportList for this measId by 1;
UE stop the periodical reporting timer, if running;
if the numberOfReportsSent as defined within the VarMeasReportList for this measId is less than the reportAmount as defined within the corresponding reportConfig for this measId:
   UE start the periodical reporting timer with the value of reportInterval as defined within the corresponding reportConfig for this measId;
else:
   if the reportType is set to periodical or cli-Periodical or rxTxPeriodical:
      UE remove the entry within the VarMeasReportList for this measId;
      UE remove this measId from the measIdList within VarMeasConfig;
if the measurement reporting was configured by a sl-ConfigDedicatedNR received within the RRCConnectionReconfiguration:
   UE submit the MeasurementReport message to lower layers for transmission via SRB1, embedded in E-UTRA RRC message ULInformationTransferIRAT;
else if the UE is in (NG)EN-DC:
   if SRB3 is configured and the SCG is not deactivated:
      UE submit the MeasurementReport message via SRB3 to lower layers for transmission, upon which the procedure ends;
   else:
      UE submit the MeasurementReport message via E-UTRA embedded in E-UTRA RRC message ULInformationTransferMRDC.
else if the UE is in NR-DC:
   if the measurement configuration that triggered this measurement report is associated with the SCG:
      if SRB3 is configured and the SCG is not deactivated:
         UE submit the MeasurementReport message via SRB3 to lower layers for transmission, upon which the procedure ends;
      else:
         UE submit the MeasurementReport message via SRB1 embedded in NR RRC message ULInformationTransferMRDC;
   else:
      UE submit the MeasurementReport message via SRB1 to lower layers for transmission, upon which the procedure ends;
else:
   UE submit the MeasurementReport message to lower layers for transmission, upon which the procedure ends.

The MeasurementReport message is used for the indication of measurement results.

-- ASN1START
-- TAG-MEASUREMENTREPORT-START

| | |
|---|---|
| MeasurementReport ::= | SEQUENCE { |
| criticalExtensions | CHOICE { |
| measurementReport | MeasurementReport-IEs, |
| criticalExtensionsFuture | SEQUENCE { } |

```
    }
  }
```

| | |
|---|---|
| MeasurementReport-IEs ::= | SEQUENCE { |
| measResults | MeasResults, |
| lateNonCriticalExtension | OCTET STRING |

OPTIONAL,

| | |
|---|---|
| nonCriticalExtension | SEQUENCE{ } |

```
OPTIONAL
  }
  -- TAG-MEASUREMENTREPORT-STOP
  -- ASN1STOP
```

At 4A10, UE receives from a base station a first radio resource control message, wherein the first radio resource control message comprises a set of parameters for measurement configuration.

At 4A20, UE performs measurement based on the set of parameters for measurement configuration.

At 4A30, UE performs, for a measurement identity, a set of operations in case that:
a report configuration associated with the measurement identity contains event trigger configuration [EventTriggerConfig];
a specific condition is fulfilled for a set of cells;
the set of cells is subset of cells of the first list; and
a specific indication is configured for the reporting configuration, wherein the specific indication relates to a second list, and wherein the second list comprises a set of cells to be reported in a second radio resource control message.

To perform the set of operations, the terminal:
stores the set of cells in the second list [cellsMetLeavingCond]
removes the set of cells from the first list [cellsTriggeredList];
sets measurement identity field in a second radio resource control message to the measurement identity;
includes the first set of cells [the cells included in the first list] with corresponding measurement results in the second radio resource control message [MeasurementReport];
includes the second set of cells [cellsMetLeavingCond; the cells included in the second list] without corresponding measurement result in the second radio resource control message; and
transmits the second radio resource control message to the base station.

The specific condition is fulfilled for a cell in case that a value determined based on measurement result of the cell is smaller than a value determined based on measurement result of special cell.

The first list is related to whether to trigger a measurement report. The second list is related to what to be reported in the measurement report.

The set of parameters for measurement configuration comprises:
one or more first subsets of parameters for report configuration;
one or more second subsets of parameters for measurement object; and
one or more third subsets of parameters for measurement identities.

Each of the one or more first subset of parameters corresponds to a report configuration. Each of the one or more second subset of parameters corresponds to a measurement object. Each of the one or more third subset of parameters corresponds to association between a specific report configuration and a specific measurement object.

The report configuration is associated with the measurement identity in case that report configuration identity of the measurement report configuration and the measurement identity are comprised in a third subset of parameters.

A first cell is included in the first list in case that:
the report configuration associated with the measurement identity contains event trigger configuration; and
a second specific condition is fulfilled for the first cell.

The second radio resource control message containing measurement result for the measurement identity is not transmitted in case that the first list associated with the measurement identity is empty.

The terminal removes cells in the second list after the second radio resource control message is transmitted.

Reporting configuration and report configuration are used interchangeably.

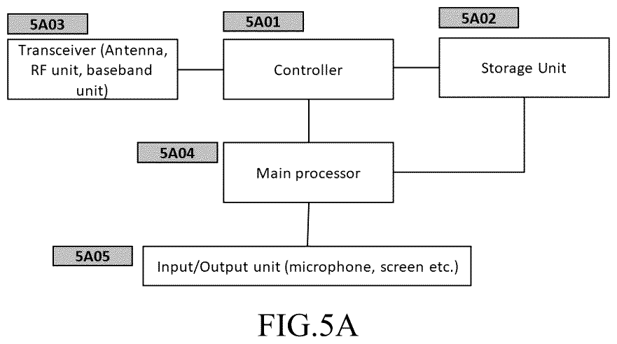

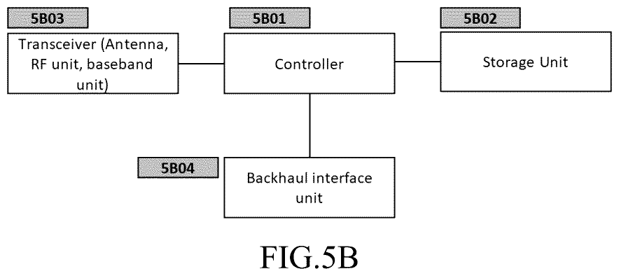

FIG. 5A is a block diagram illustrating the internal structure of a terminal to which the disclosure is applied.

Referring to the diagram, the terminal includes a controller (5A01), a storage unit (5A02), a transceiver (5A03), a main processor (5A04) and I/O unit (5A05).

The controller (5A01) controls the overall operations of the terminal in terms of mobile communication. For example, the controller (5A01) receives/transmits signals through the transceiver (5A03). In addition, the controller (5A01) records and reads data in the storage unit (5A02). To this end, the controller (5A01) includes at least one processor. For example, the controller (5A01) may include a communication processor (CP) that performs control for communication and an application processor (AP) that controls the upper layer, such as an application program. The controller controls storage unit and transceiver such that UE operations illustrated in this disclosure are performed.

The storage unit (5A02) stores data for operation of the terminal, such as a basic program, an application program, and configuration information. The storage unit (5A02) provides stored data at a request of the controller (5A01).

The transceiver (5A03) consists of a RF processor, a baseband processor and plurality of antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mi10r, an oscillator, a digital-to-analog converter (DAC), an analog-to-digital converter (ADC), and the like. The RF processor may perform MIMO and may receive multiple layers when performing the MIMO operation. The baseband processor performs a function of conversion between a baseband signal and a bit string according to the physical layer specification of the system. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The main processor (5A04) controls the overall operations other than mobile operation. The main processor (5A04) process user input received from I/O unit (5A05), stores data in the storage unit (5A02), controls the controller (5A01) for required mobile communication operations and forward user data to I/O unit (5A05).

I/O unit (5A05) consists of equipment for inputting user data and for outputting user data such as a microphone and a screen. I/O unit (5A05) performs inputting and outputting user data based on the main processor's instruction.

FIG. 5B is a block diagram illustrating the configuration of a base station according to the disclosure.

As illustrated in the diagram, the base station includes a controller (5B01), a storage unit (5B02), a transceiver (5B03) and a backhaul interface unit (5B04).

The controller (5B01) controls the overall operations of the main base station. For example, the controller (5B01) receives/transmits signals through the transceiver (5B03), or through the backhaul interface unit (5B04). In addition, the controller (5B01) records and reads data in the storage unit (5B02). To this end, the controller (5B01) may include at least one processor. The controller controls transceiver, storage unit and backhaul interface such that base station operation illustrated in FIG. 2A are performed.

The storage unit (5B02) stores data for operation of the main base station, such as a basic program, an application program, and configuration information. Particularly, the storage unit (5B02) may store information regarding a bearer allocated to an accessed UE, a measurement result reported from the accessed UE, and the like. In addition, the storage unit (5B02) may store information serving as a criterion to determine whether to provide the terminal with multi-connection or to discontinue the same. In addition, the storage unit (5B02) provides stored data at a request of the controller (5B01).

The transceiver (5B03) consists of a RF processor, a baseband processor and plurality of antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mi10r, an oscillator, a DAC, an ADC, and the like. The RF processor may perform a down link MIMO operation by transmitting at least one layer. The baseband processor performs a function of conversion between a baseband signal and a bit string according to the physical layer specification of the first radio access technology. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The backhaul interface unit (5B04) provides an interface for communicating with other nodes inside the network. The backhaul interface unit (5B04) converts a bit string transmitted from the base station to another node, for example, another base station or a core network, into a physical signal, and converts a physical signal received from the other node into a bit string.

Below lists acronym used in the present disclosure.

| | | | |
|---|---|---|---|
| 5GC | 5G Core Network | RACH | Random Access Channel |
| ACK | Acknowledgement | RAN | Radio Access Network |
| AM | Acknowledged Mode | RAR | Random Access Response |
| AMF | Access and Mobility Management Function | | |
| RA-RNTI | Random Access RNTI | | |
| ARQ | Automatic Repeat Request | RAT | Radio Access Technology |
| AS | Access Stratum | RB | Radio Bearer |
| ASN.1 | Abstract Syntax Notation One | RLC | Radio Link Control |
| BSR | Buffer Status Report | RNA | RAN-based Notification Area |
| BWP | Bandwidth Part | RNAU | RAN-based Notification Area Update |
| CA | Carrier Aggregation | RNTI | Radio Network Temporary Identifier |
| CAG | Closed Access Group | RRC | Radio Resource Control |
| CG | Cell Group | RRM | Radio Resource Management |
| C-RNTI | Cell RNTI | RSRP | Reference Signal Received Power |
| CSI | Channel State Information | RSRQ | Reference Signal Received Quality |
| DCI | Downlink Control Information | RSSI | Received Signal Strength Indicator |
| DRB | (user) Data Radio Bearer | SCell | Secondary Cell |
| DTX | Discontinuous Reception | SCS | Subcarrier Spacing |
| HARQ | Hybrid Automatic Repeat Request | | |
| SDAP | Service Data Adaptation Protocol | | |
| IE | Information element | SDU | Service Data Unit |
| LCG | Logical Channel Group | SFN | System Frame Number |
| MAC | Medium Access Control | S-GW | Serving Gateway |
| MIB | Master Information Block | SI | System Information |
| NAS | Non-Access Stratum | SIB | System Information Block |
| NG-RAN | NG Radio Access Network | SpCell | Special Cell |
| NR | NR Radio Access | SRB | Signalling Radio Bearer |
| PBR | Prioritised Bit Rate | SRS | Sounding Reference Signal |
| PCell | Primary Cell | SS | Search Space |
| PCI | Physical Cell Identifier | SSB | SS/PBCH block |
| PDCCH | Physical Downlink Control Channel | | |
| SSS | Secondary Synchronisation Signal | | |
| PDCP | Packet Data Convergence Protocol | SUL | Supplementary Uplink |
| PDSCH | Physical Downlink Shared Channel | | |
| TM | Transparent Mode | | |
| PDU | Protocol Data Unit | UCI | Uplink Control Information |
| PHR | Power Headroom Report | UE | User Equipment |
| PLMN | Public Land Mobile Network | UM | Unacknowledged Mode |
| PRACH | Physical Random Access Channel | | |
| CRP | Cell Reselection Priority | | |
| PRB | Physical Resource Block | PSS | Primary Synchronisation Signal |
| PUCCH | Physical Uplink Control Channel | | |
| PUSCH | Physical Uplink Shared Channel | | |

What is claimed is:

1. A method performed by a terminal, the method comprising:
receiving from a base station a first radio resource control message, wherein the first radio resource control message comprises a set of parameters for measurement configuration;
performing measurement based on the set of parameters for measurement configuration; and
performing, for a measurement identity, a set of operations in case that:
a report configuration associated with the measurement identity contains event trigger configuration;
a specific condition is fulfilled for a set of cells;
the set of cells is subset of cells of a first list; and
a specific indication is configured for the report configuration, wherein the specific indication relates to a second list, and wherein the second list comprises a set of cells to be reported in a second radio resource control message;
wherein, to perform the set of operations, the terminal:
stores the set of cells in the second list;
removes the set of cells from the first list;
sets measurement identity field in the second radio resource control message to the measurement identity;
includes a first set of cells with corresponding measurement results in the second radio resource control message, wherein the first set of cells comprises cells of the first list;
includes a second set of cells without corresponding measurement result in the second radio resource control message, wherein the second set of cells comprises cells of the second list; and
transmits the second radio resource control message to the base station.

2. The method of claim 1,
wherein the specific condition is fulfilled for a cell in case that a value determined based on measurement result of the cell is smaller than a value determined based on measurement result of a special cell.

3. The method of claim 1, wherein:
the first list is related to whether to trigger a measurement report; and
the second list is related to what to be reported in the measurement report.

4. The method of claim 1,
wherein the set of parameters for measurement configuration comprises:
one or more first subsets of parameters for report configuration;
one or more second subsets of parameters for measurement object; and
one or more third subsets of parameters for measurement identities.

5. The method of claim 4, wherein:
each of the one or more first subset of parameters corresponds to the report configuration;
each of the one or more second subset of parameters corresponds to a measurement object; and
each of the one or more third subset of parameters corresponds to association between a specific report configuration and a specific measurement object.

6. The method of claim 5, wherein:
the report configuration is associated with the measurement identity in case that report configuration identity of the report configuration and the measurement identity are comprised in a third subset of parameters.

7. The method of claim 1,
wherein a first cell is included in the first list in case that:
the report configuration associated with the measurement identity contains event trigger configuration; and
a second specific condition is fulfilled for the first cell.

8. The method of claim 1,
wherein the second radio resource control message containing measurement result associated with the measurement identity is not transmitted in case that the first list associated with the measurement identity is empty.

9. The method of claim 1,
wherein the terminal removes cells in the second list after the second radio resource control message is transmitted.

10. A terminal in a wireless communication system, the terminal comprising:
a transceiver configured to transmit and receive a signal; and
a controller configured to control the transceiver to:
receive from a base station a first radio resource control message, wherein the first radio resource control message comprises a set of parameters for measurement configuration,
perform measurement based on the set of parameters for measurement configuration, and
perform, for a measurement identity, a set of operations in case that:
a report configuration associated with the measurement identity contains event trigger configuration;
a specific condition is fulfilled for a set of cells;
the set of cells is subset of cells of a first list; and
a specific indication is configured for the report configuration, wherein the specific indication relates to a second list, and wherein the second list comprises a set of cells to be reported in a second radio resource control message, and
wherein, to perform the set of operations, the terminal:
stores the set of cells in the second list;
removes the set of cells from the first list;
sets measurement identity field in the second radio resource control message to the measurement identity;
includes a first set of cells with corresponding measurement results in the second radio resource control message, wherein the first set of cells comprises cells of the first list;
includes a second set of cells without corresponding measurement result in the second radio resource control message, wherein the second set of cells comprises cells of the second list; and
transmits the second radio resource control message to the base station.
